(19) United States
(12) Patent Application Publication
(10) Pub. No.: US 2020/0050711 A1
(43) Pub. Date: Feb. 13, 2020

(54) SERVER FOR CONFIGURING AND INTEGRATING OBJECTS FROM EXTERNAL LIBRARY INTO USER'S BUILDING INFORMATION MODEL AND DETERMINING COMPLIANCE WITH PREDETERMINED STANDARDS

(71) Applicant: UNIFI LABS, INC., Las Vegas, CA (US)

(72) Inventors: Megan GREEN, Las Vegas, NV (US); Mark ESLINGER, Las Vegas, NV (US); Matthew MORGAN, Las Vegas, NV (US)

(21) Appl. No.: 16/056,966

(22) Filed: Aug. 7, 2018

(51) Int. Cl. G06F 17/50

(52) U.S. Cl. CPC G06F 17/5004; G06F 2217/04

(57) ABSTRACT

The invention relates to an integration server for receiving objects from an external source, for example a library from a first server operated by a manufacturer, configuring the objects according to specifications received from a second server operated by an AEC (architecture, engineering, or construction) professional, and making the configured objects available to the second server in a BIM (building information model) file within a computer-aided design application. The integration server analyzes the project file, including the use of the configured objects in the BIM file, and identifies any inconsistencies with global and project-specific standards. This analysis identifies any elements or characteristics that may increase the likelihood that the BIM file eventually will crash or become corrupted so that the user can address those issues. For manufacturer-provided objects, the integration server provides a report to the manufacturer server regarding the usage of its objects.

### TECHNICAL FIELD

The present invention relates to an integration server for receiving objects from an external source, for example a library from a first server operated by a manufacturer, configuring the objects according to specifications received from a second server operated by an AEC (architecture, engineering, or construction) professional, and making the configured objects available to the second server for use in a BIM (building information model) file within a computer-aided design application. The integration server analyzes the project file, including the use of the configured objects in the BIM file, and identifies any inconsistencies with global and project-specific standards. This analysis identifies any elements or characteristics that may increase the likelihood that the BIM file eventually will crash or become corrupted (for example, if the file is taking an exceedingly long time to sync to the server, which generally indicates an unhealthy state of the file) so that the user can proactively address those issues. In the instance where it was a manufacturer-provided object, the integration server also provides a report to the manufacturer server regarding the usage of its objects.

### BACKGROUND OF THE INVENTION

The prior art includes numerous examples of CAD (computer-aided design) applications that can be used by professionals in an AEC field to build a BIM file. FIG. 22 depicts prior art system 2200, which comprises AEC network 2206, manufacturer network 2207, and Internet 2203. AEC network 2206 comprises AEC server 2202 and exemplary clients 2201a and 2201b. Manufacturer network 2207 comprises manufacturer server 2204 and exemplary clients 2205a and 2205b.

An AEC user typically creates a BIM file on client 2201a or 2201b that is hosted on AEC server 2202 for a project. BIM files typically are created when a new building is designed and constructed. BIM files can contain every aspect of a building's design, including the overall shape and dimensions of the building, the materials used for the structure of the building, the layout and structure of various systems (such as electrical, plumbing, heating, ventilation, air-conditioning, fire alarm, security, computer network, elevator, and other systems), the actual products used within such systems, the design of individual floors and rooms within the building, flooring, furniture, signage, art work, and other aspects of the external and internal design of the building.

Manufacturers typically design objects used by the AEC professionals in designing and construing their buildings and the BIM files. For example, a manufacturer may specialize in the design of lighting fixtures used in buildings. Another manufacturer may specialize in the design of plumbing components used in buildings. Manufacturers create objects in files using clients 2205a or 2205b that are hosted on manufacturer server 2204.

In prior art system 2200, when an AEC professional wishes to use an object supplied by an external source, for example created by a manufacturer, it typically is very tedious and inefficient to do so. AEC server 2202 and manufacturer server 2204 do not communicate directly. Instead, users or administrators communicate over Internet 2203 by email, web access, ftp access, or other known communication mechanisms. An AEC user might be inundated with electronic files supplied by dozens of manufacturers who wish for that AEC to use its products. Even when an AEC is able to find an object it likes, the object often contains a much larger set of data than is needed by the AEC. For example, a lighting fixture might have 50 data points associated with it (e.g., dimensions, materials, lumens per bulb, number of bulbs, type of bulbs, type of mounting required, etc.), but an AEC might need only 10 of those data points. In prior art system 2200, even when an AEC obtains an object (such as by email from the manufacturer), there has been no effective way of paring down objects to include only those data points that are needed by the AEC. This causes the BIM file for a project to be larger than it needs to be. As the BIM file incorporates more and more objects, the file will become prohibitively large due to the inclusion of data points that it does not need.

In addition, the prior art has no mechanism for automatically identifying inconsistencies between an object to be inserted into a BIM file (for objects received from outside sources such as a manufacturer server as well as objects created internally within the BIM environment) and the standards for the design that have been established by the AEC. For example, an AEC may create a standard for a BIM file that includes a set of rules, such as all internal lighting fixtures must use only LED (light emitting diode) bulbs. If the AEC then wishes to add a lighting fixture designed internally or by a third-party that uses traditional bulbs, the prior art does not have an automatic mechanism for identifying that inconsistency when the object is added to the BIM file. Instead, the prior art has relied upon the AEC to understand the standards and to ensure that each object he or she places in the file to be compliant with all applicable standards.

In addition, the prior art does not include a mechanism for an object designer to be provided with feedback on how its object is being used by AECs. For example, the designer does not know how often its object is used in a model and what types of models and AECs have used its object.

What is needed is a system that facilitates the use of objects in a BIM file, where an object can be selected by an AEC for use in a BIM file and the object can be pared down to include only the data points of interest. What is further needed is a system that can determine whether an object to be added has any compliance issues with standards for the building and whether any such compliance issues are of the type that likely will cause the BIM file to become corrupted or crash. What is further needed is a system that can provide feedback to a manufacturer regarding the use of its objects in BIM files.

### SUMMARY OF THE INVENTION

The present invention relates to an integration server for receiving objects from an external library from a first server operated by an external source (i.e. a manufacturer), configuring the objects according to specifications received from a second server operated by an AEC (architecture, engineering, or construction) professional, and making the configured objects available to the second server for use in a BIM (building information model) file within a computer-aided design application. The integration server analyzes the project file, including the use of the configured objects in the BIM model, and identifies any inconsistencies with global and project-specific standards. This analysis identifies any elements or characteristics that may increase the likelihood that the BIM file eventually will crash or become corrupted (for example, if the file is taking an exceedingly long time to sync to the server, which generally indicates an unhealthy state of the file) so that the user can proactively address those issues. In the instance where it was a manufacturer-provided object, the integration server also provides a report to the manufacturer server regarding the usage of its objects.

### BRIEF DESCRIPTION OF THE DRAWINGS

FIG. 1 depicts a building design system.

FIG. 2A depicts hardware components of a client.

FIG. 2B depicts software components of a client.

FIG. 3A depicts hardware components of an AEC server.

FIG. 3B depicts software components of an AEC server.

FIG. 4A depicts hardware components of an integration server.

FIG. 4B depicts software components of an integration server.

FIG. 5A depicts hardware components of a manufacturer server.

FIG. 5B depicts software components of a manufacturer server.

FIG. 6A depicts hardware components of another client.

FIG. 6B depicts software components of another client.

FIG. 7 depicts additional aspects of the building design system.

FIGS. 8A-8E depict a sequence of requesting, obtaining, and using an object in a project file within the building design system.

FIG. 9 depicts an embodiment of a compliance module.

FIGS. 10A-10F depict an Overview Tab of a Project Space Level view in a dashboard.

FIG. 11 depicts a Projects Tab of a Project Space Level view in a dashboard.

FIG. 12 depicts a Settings Tab of a Project Space Level view in a dashboard.

FIGS. 13A-13E depict an Overview Tab of a Project Level view in a dashboard.

FIG. 14 depicts a Models Tab of a Project Level view in a dashboard.

FIG. 15 depicts a Syncs Tab of a Project Level view in a dashboard.

FIG. 16 depicts a Libraries & Channels Tab of a Project Level view in a dashboard.

FIG. 17 depicts a Settings Tab of a Project Level view in a dashboard.

FIGS. 18A-18F depict an Overview Tab of a Model Level view in a dashboard.

FIGS. 19A-19E depicts a Content Tab of a Model Level view in a dashboard.

FIGS. 20A-20B depict a Compare Changes Tab of a Model Level view in a dashboard.

FIG. 21 depicts manufacturer analytics collected by an integration server for a manufacturer server.

FIG. 22 depicts a prior art system used by AEC users and manufacturers.

### DETAILED DESCRIPTION OF THE PREFERRED EMBODIMENTS

### Overview of Hardware and Software Architecture

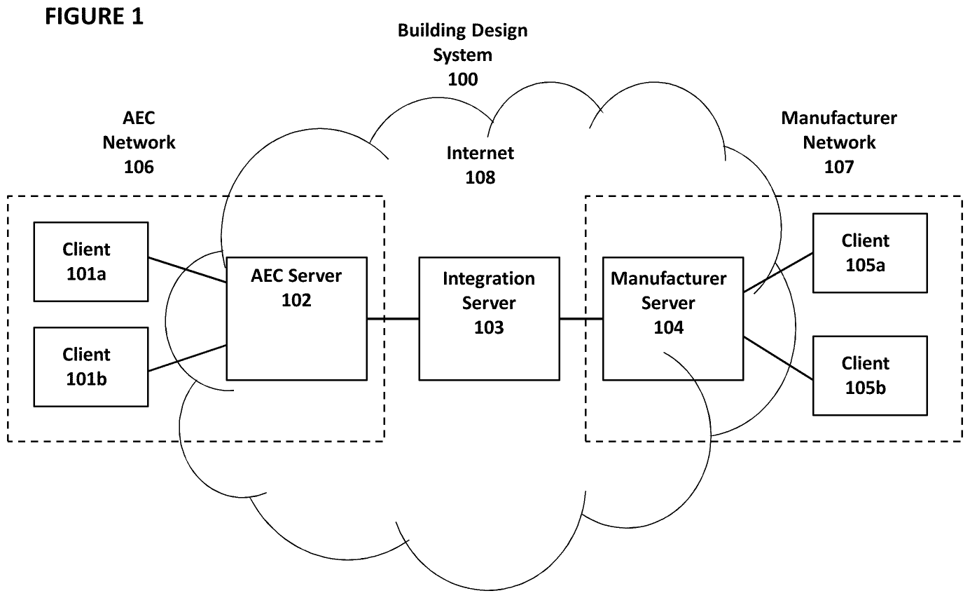

FIG. 1 depicts building design system 100. Building design system 100 comprises exemplary AEC network 106, exemplary integration server 103, and exemplary manufacturer network 107. It is to be understood that any number of other AEC networks, integration servers, and manufacturer servers can be included in building design system 100.

In this example, AEC network 106 comprises clients 101a and 101b and AEC server 102. Typically, AEC network is operated by an engineering, architecture, and/construction company and is used to create designs for a building project.

Manufacturer network 107 comprises clients 105a and 105b and manufacturer server 104. Typically, manufacturer network 107 is operated by a manufacturer who makes physical items that can be used in a building project, such as plumbing fixtures, electrical fixtures, flooring, furniture, doors, windows, insulation, etc.

Integration server 103 is a critical component of the embodiments described herein, and provides a mechanism of interaction and communication between AEC server 102 and manufacturer server 104 that did not exist in the prior art. AEC server 102, integration server 103, and manufacturer server 104 communicate over Internet 108 or another network.

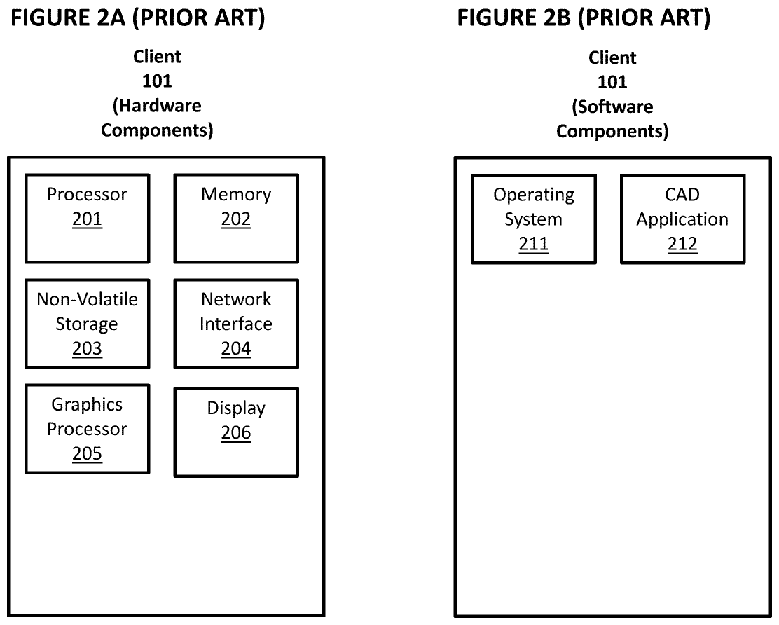

FIG. 2A depicts hardware components of client 101 (such as client 101a and client 101b). These hardware components are known in the prior art. Client 101a comprises processor 201, memory 202, non-volatile storage 203, network interface 204, graphics processor 205, and display 206. Client 101 can be a server, notebook computer, desktop computer, game system, smartphone, or other computing device.

Processor 201 comprises one or more microprocessors, each with one or more processing cores. Memory 202 comprises DRAM or SRAM volatile memory or other types of volatile memory. Non-volatile storage 203 comprises a hard disk drive, flash memory array, or other types of non-volatile storage. Network interface 204 comprises a wired interface (e.g., Ethernet interface) or wireless interface (e.g., 3G, 4G, GSM, 802.11, protocol known by the trademark “Bluetooth,” etc.). Graphics processor 205 comprises a controller or processor for generating graphics for display and is useful for rendering complicated drawings and objects in computer-aided design (CAD) applications typically used by engineers and architects. Display 206 displays the graphics generated by graphics processor 205, and optionally comprises a monitor, touchscreen, or other type of display.

FIG. 2B depicts software components of client 101. These software components are known in the prior art. Client 101 comprises operating system 211 (such as the operating systems known by the trademarks “Windows,” “Linux,” “Android,” “iOS,” or others) and CAD application 212 (such as the CAD application known by the trademark “Revit”) CAD application 212 comprises lines of software code executed by processor 201 to provide a CAD environment for the end-user to design a building or other object.

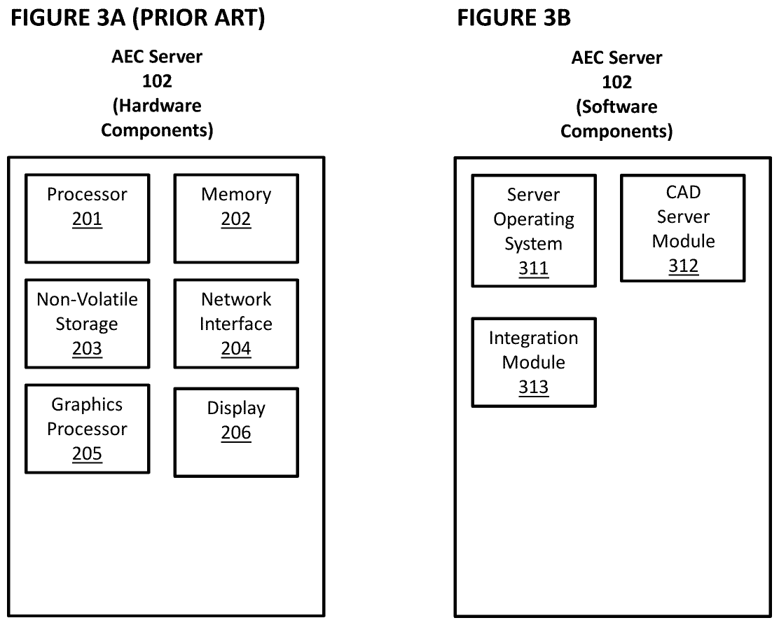

FIG. 3A depicts hardware components of AEC server 102. These hardware components are known in the prior art, and typically are the same functional components used in client 101. Thus, AEC server 102 comprises processor 201, memory 202, non-volatile storage 203, network interface 204, graphics processor 205, and display 206. Client 101 can be a server, notebook computer, desktop computer, game system, smartphone, or other computing device.

FIG. 3B depicts software components of AEC server 102. AEC server 102 comprises server operating system 311 (such as the server-side operating systems known by the trademarks “Windows,” “Linux,” “Android,” “iOS,” or others), CAD server module 312 (such as the CAD server application known by the trademark “Revit”) and integration module 313. Server operating system 311 and CAD server module 312 are known in the prior art. However, integration module 313 is not known in the prior art and is a component of the present invention. Integration module 313 comprises lines of software code that can be executed by processor 201 of AEC server 102.

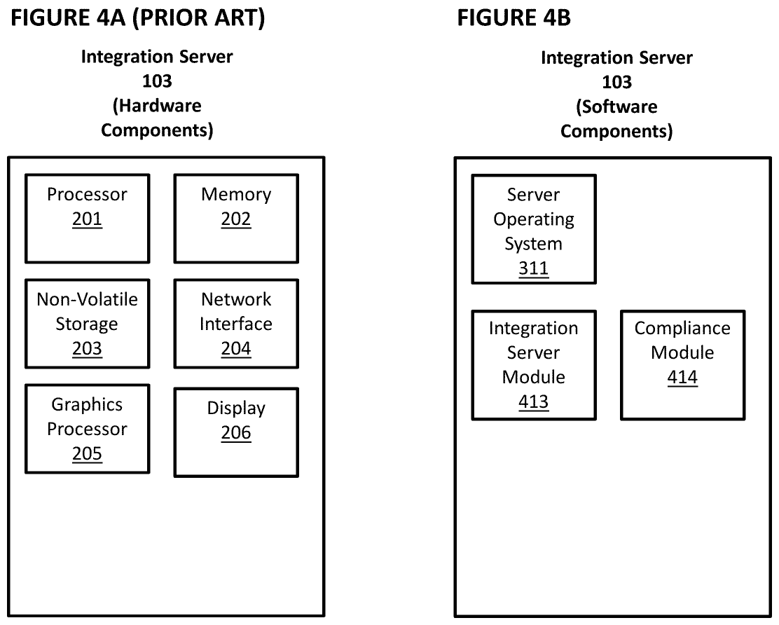

FIG. 4A depicts hardware components of integration server 103. These hardware components are known in the prior art, and typically are the same functional components used in client 101. Thus, AEC server 102 comprises processor 201, memory 202, non-volatile storage 203, network interface 204, graphics processor 205, and display 206. Integration server 103 can be a server or other computing device.

FIG. 4B depicts software components of integration server 103. Integration server 103 comprises server operating system 311 (as in AEC server 102) integration server module 413, and compliance module 414. Integration server module 413 and compliance module 414 are not known in the prior art and each are components of the present invention. Integration server module 413 and compliance module 414 each comprises lines of software code that can be executed by processor 201 of integration server 103.

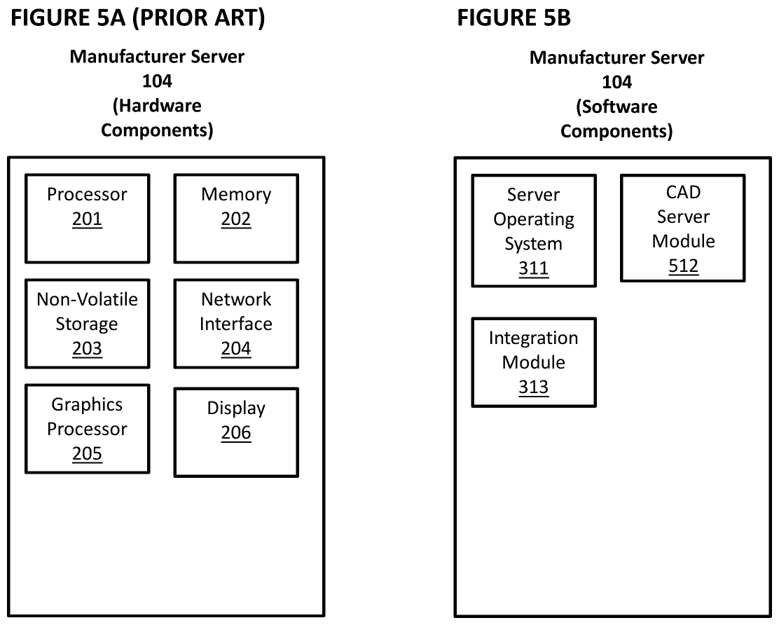

FIG. 5A depicts hardware components of manufacturer server 104. These hardware components are known in the prior art, and typically are the same functional components used in client 101. Thus, manufacturer server 104 comprises processor 201, memory 202, non-volatile storage 203, network interface 204, graphics processor 205, and display 206. Manufacturer server 104 can be a server or other computing device.

FIG. 5B depicts software components of manufacturer server 104. Manufacturer server 104 comprises server operating system 311 (as described previously with reference to FIG. 3), CAD server module 512 (such as the CAD server application known by the trademark “Revit”) and integration module 313 (as described previously with reference to FIG. 3). Server operating system 311 and CAD server module 512 are known in the prior art. However, integration module 313 is not known in the prior art and is a component of the present invention.

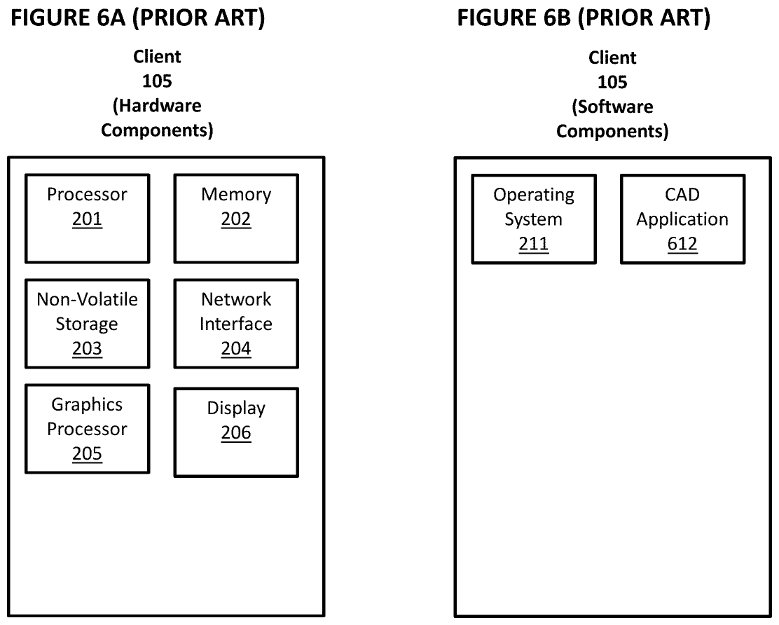

FIG. 6A depicts hardware components of client 105. These hardware components are known in the prior art, and typically are the same functional components used in client 101. Thus, AEC server 102 comprises processor 201, memory 202, non-volatile storage 203, network interface 204, graphics processor 205, and display 206. Client 105 can be a server, notebook computer, desktop computer, game system, smartphone, or other computing device.

FIG. 6B depicts software components of client 105. These software components are known in the prior art. Client 105 comprises operating system 211 (as described previously with reference to FIG. 2) and CAD application 612 (such as the CAD application known by the trademark “Revit”). CAD application 612 comprises lines of software code executed by processor 201 to provide a CAD environment for the end-user to design a product or object to be used in a building.

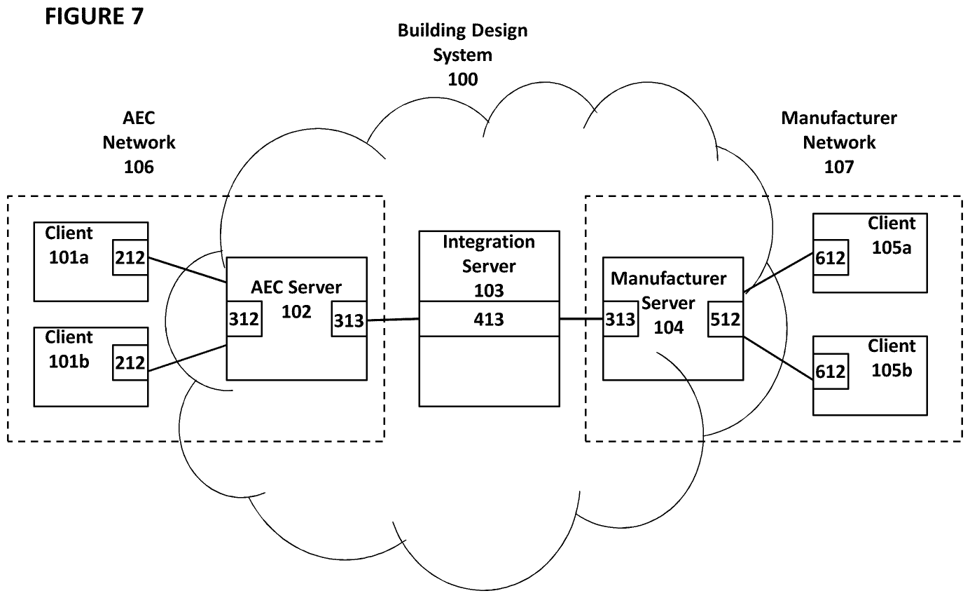

FIG. 7 depicts additional aspects of building system 100. CAD application 212 in clients 101a and 101b communicate with CAD server application 312 in AEC server 102, providing a networked client-server environment for CAD design for the AEC. Similarly, CAD application 612 in clients 105a and 105b communicate with CAD server application 512 in manufacturer server 104, providing a networked client-server environment for CAD design for the manufacturer.

Integration module 313 in AEC server 102 and integration module 313 in manufacturer server 104 communicate with integration server module 413 in integration server 103 to provide the functions described in greater detail below.

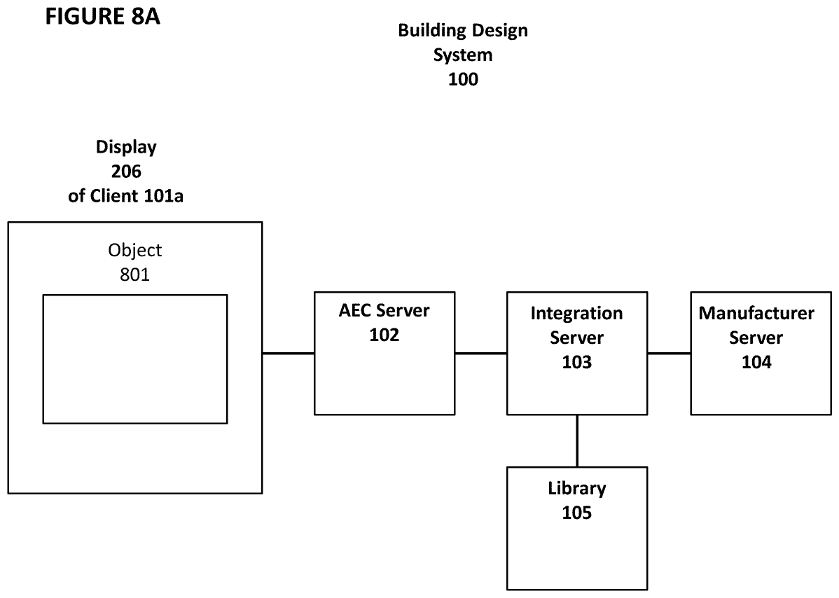

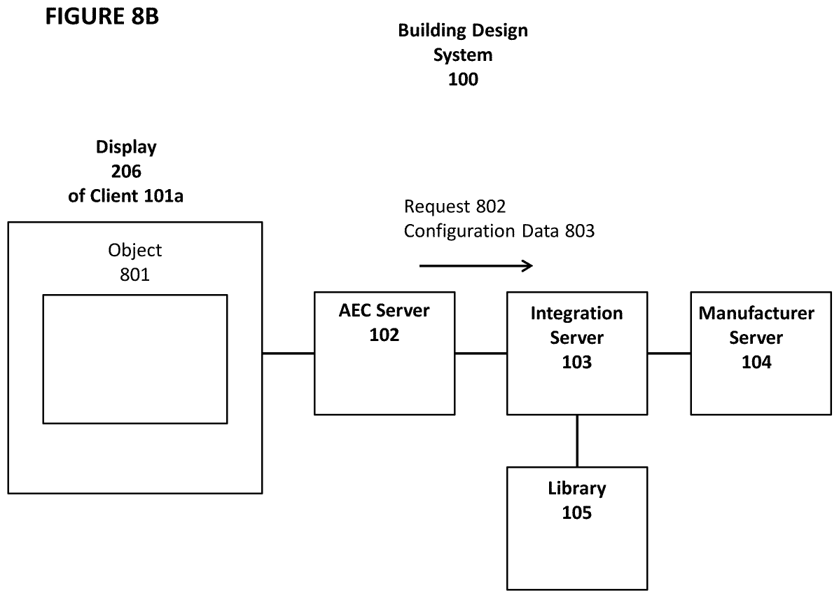

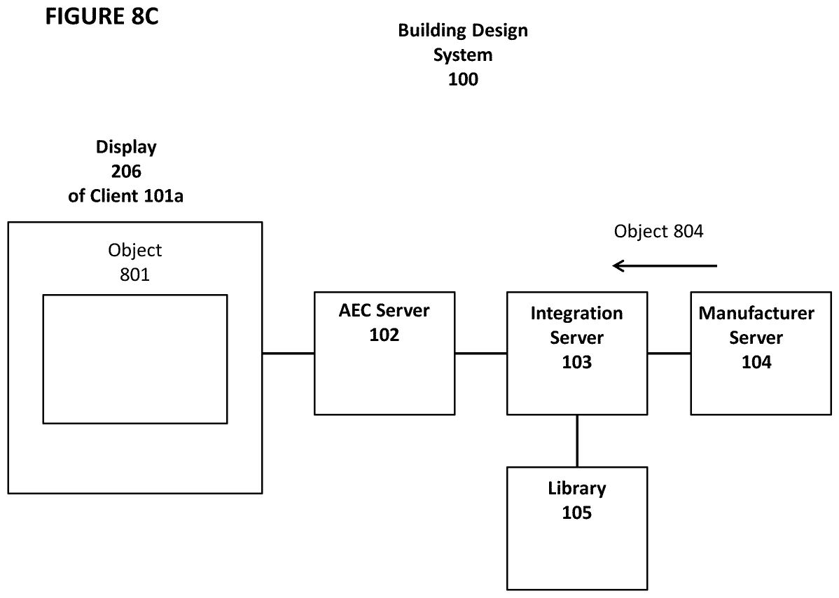

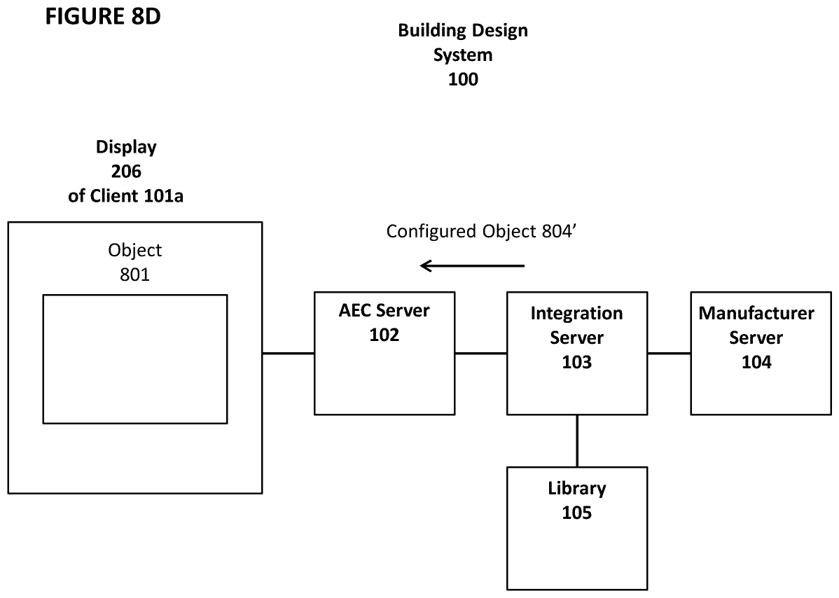

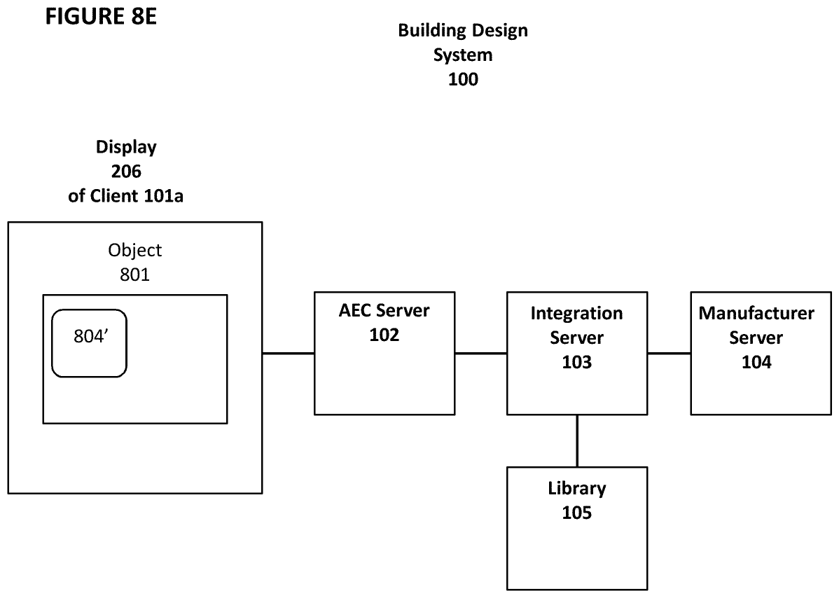

FIGS. 8A-8E depict an exemplary sequence of integrating an object from manufacturer server 104 in a project created by client 101 in conjunction with AEC server 102.

In FIG. 8A, a user of client 101 creates object 801. In this example, object 801 is a floorplan for a floor in a building being designed by the user of client 101.

In FIG. 8B, AEC server 102 sends request 802 to integration server 103. The request might be a request to obtain data for an object made available by manufacturer server 104, or it might be a request to obtain data for an object resident in library 105 accessible by integration server 103 that was originally created by manufacturer server 104.

AEC server 102 also sends configuration data 803 to integration server 103. Configuration data 803 reflects characteristics requested or specified by AEC server 102 for the requested object. For instance, configuration data 803 might identify the subset of data points of all available data points for the requested object that AEC server 102 wishes to obtain. For example, the requested object may have 40 total data points. Configuration data 803 might indicate 17 data points that AEC server 102 wishes to receive.

In FIG. 8C, manufacturer server 104 sends object 804 to integration server 103 in response to request 802. Optionally, object 804 might already reside in library 105, in which case, integration server 103 will obtain object 804 from library 105.

In FIG. 8D, integration server 804 modifies object 804 based on configuration data 803. For example, if configuration data 803 identifies a subset of data points that AEC server 102 wishes to obtain, then integration server 103 will strip out the data points that are not requested from object 804. If configuration data 803 requests a data point that does not exist in object 804, then integration server 103 can supplement object 804 by calculating the data point or obtaining it from another source and adding it to object 804. The end result is configured object 804′, which represents the configured version of object 804.

In FIG. 8E, the user of client 101 adds a visual representation of object 804′ into the visual representation of object 801. If object 801 is a floorplan, then object 804′ might be an HVAC (heater-ventilation-air conditioning) unit, a table, or other item that an engineer or architect might place in a floorplan design.

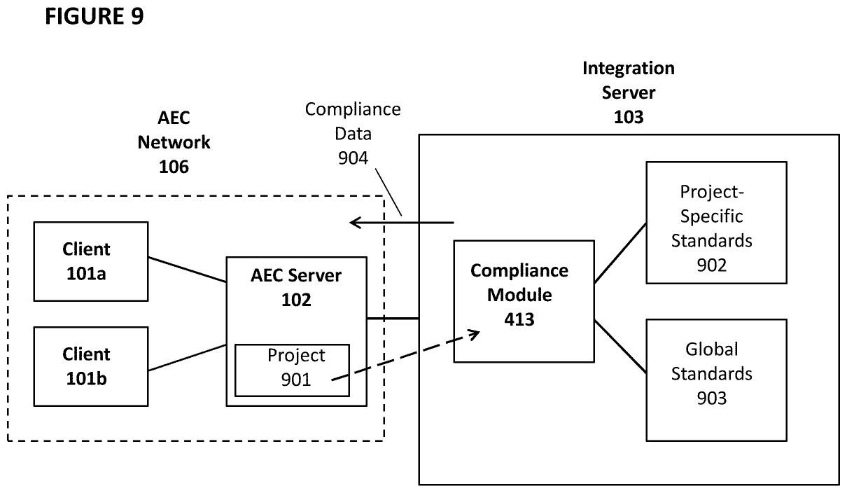

FIG. 9 depicts another aspect of the invention. An AEC generates project 901 within AEC server 102. Compliance module 413 within integration server 103 accesses project-specific standards 902 and global standards 903.

Global standards 903 are standards (i.e., sets of rules) that apply to multiple projects, such as all projects created by the AEC or all projects which utilize integration server 103. Global standards 903 optionally include local building codes and known best practices (e.g., all electrical outlets in a bathroom must be GFCI (ground-fault circuit interrupter) outlets).

Project-specific standards 902 are standards established by the AEC specifically for project 901 (e.g., all tables in conference rooms must be constructed of wood).

Compliance module 413 analyzes every change (including, but not limited to, the addition of a new object created internally within AEC network 106 or from manufacturer network 107) to project 901 to determine if the change complies with standards 902 and global standards 903. Compliance module 413 can be configured to perform this analysis at various stages within the lifecycle of project 901. For example, compliance module 413 can be configured to analyze a change: (1) As soon as the change is made; (2) Whenever project 901 is saved to non-volatile storage 203; (3) Upon request by a user; (4) At a set time (e.g., end of each day or every hour); or (5) Upon the occurrence of any other event or circumstance established by the user. As an alternative or supplemental option, compliance module 413 can determine compliance of project 901 as a whole (as opposed to a specific change).

After the analysis is performed, compliance module 413 generates and sends compliance data 904 to indicate any inconsistencies between the changes in project 901 (or project 901 as a whole) and project-specific-standards 902 and global standards 903. Compliance data 904 can be used as a basis for generating health indicators for project 901, as discussed in greater detail below.

### Exemplary Analytics and Dashboard

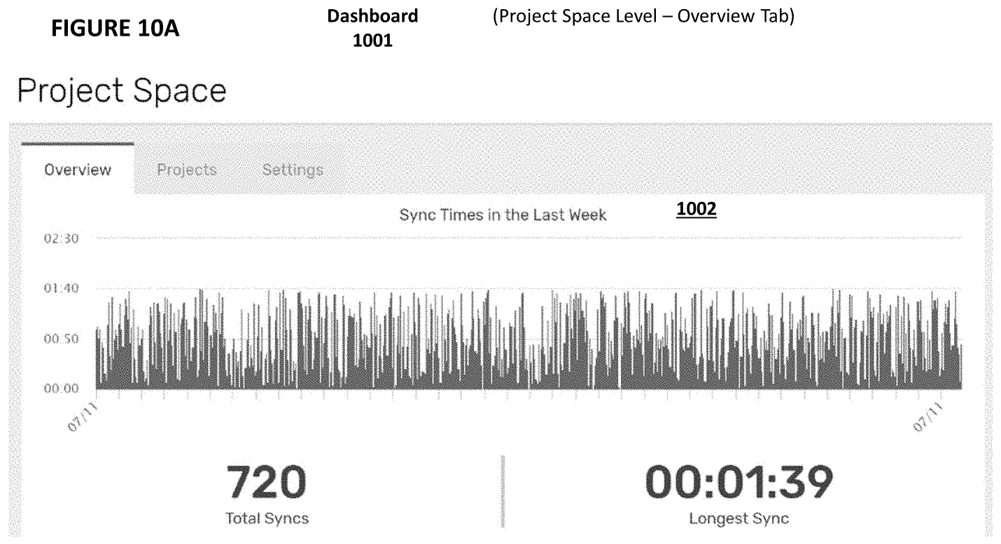

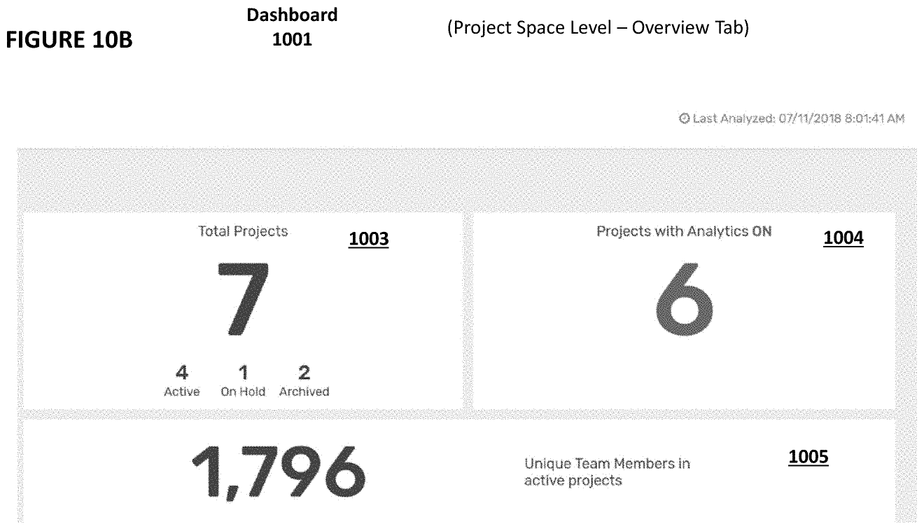

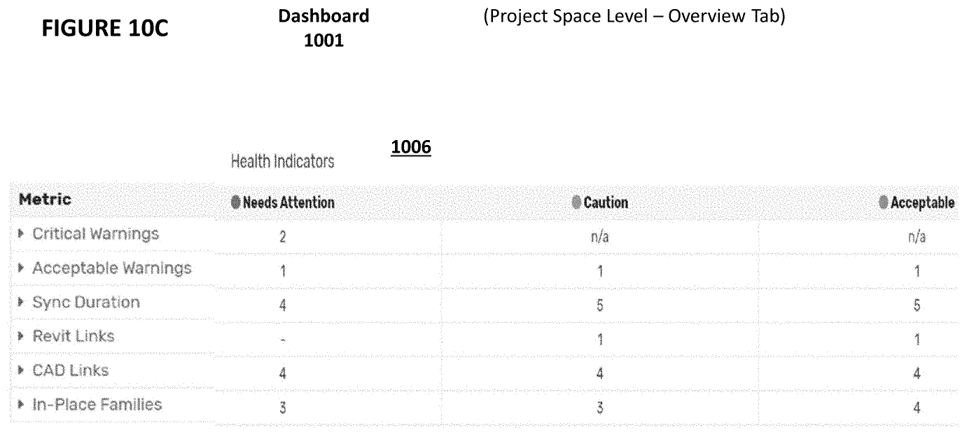

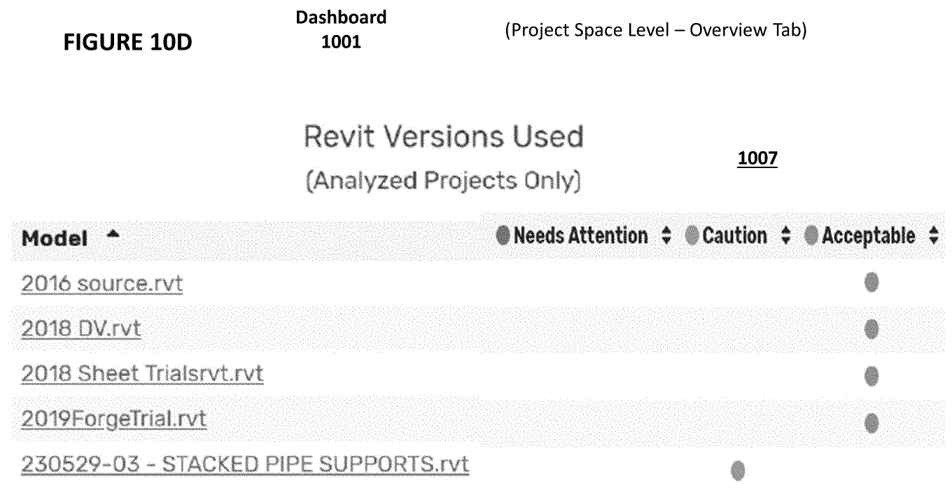

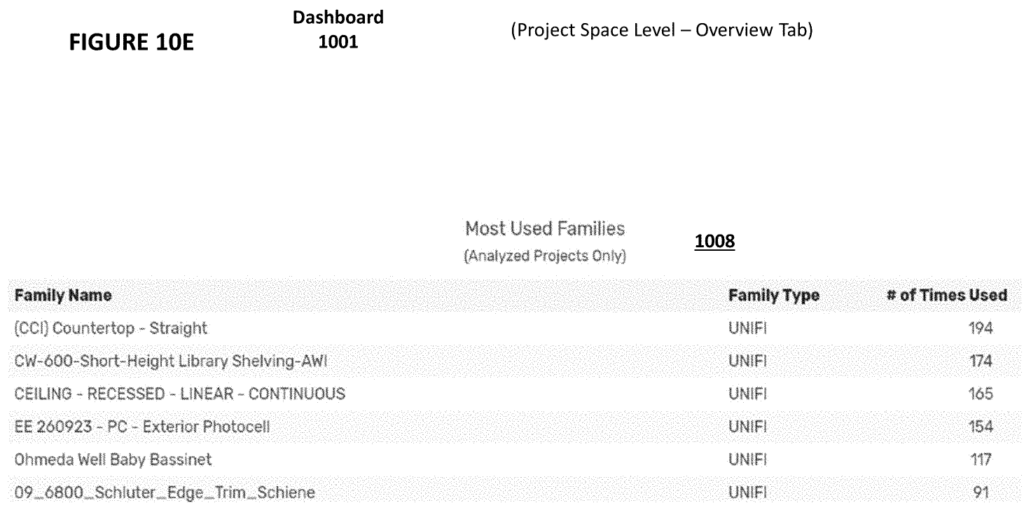

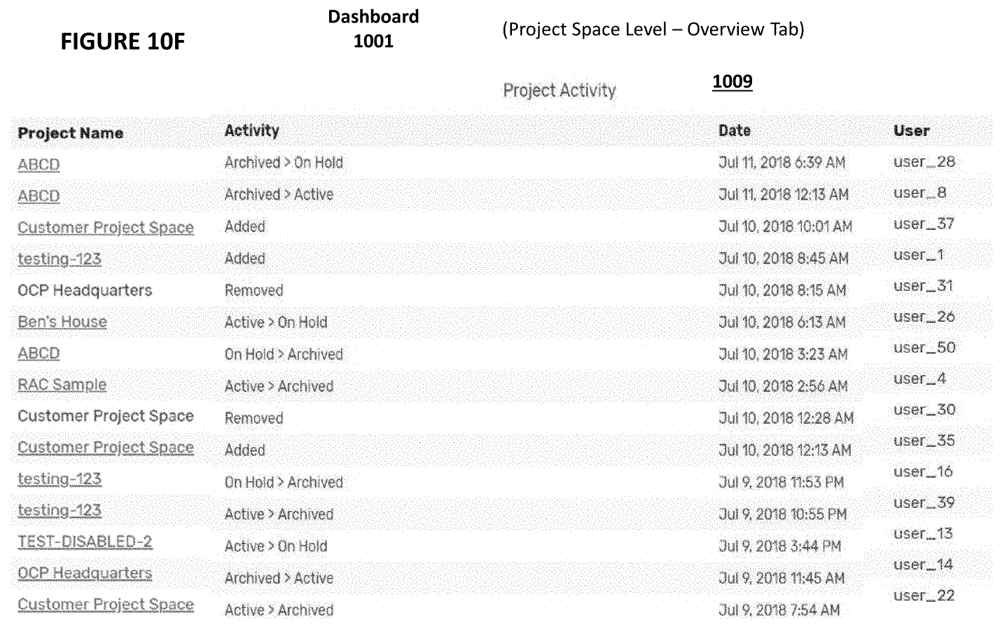

With reference to FIGS. 10-20, AEC server 102 optionally can generate dashboard 1001 for any client 101 to provide analytics such as the exemplary analytics discussed below for all projects hosted on AEC server 102 and for each specific project.

FIGS. 10-12 depict the “Project Space Level” view within dashboard 1001. At this level, users can see an overview of project health-related information associated with the projects hosted by AEC server 10 as of the most recent sync (e.g., the updating of project 901 on AEC server 10 by clients 101). In this example, AEC Server 102 is running the CAD application known by the trademark “Revit.”

FIGS. 10A-10F depict the “Overview” tab of the Project Space view, which contains the following information:
Sync Times in the Last Week (Item 1002)
   This graph displays the time it took for each Revit sync operation. The user can click on any bar in this graph and it will take them to the corresponding Model's overview page.
   Statistics are shown for the total number of syncs, average sync time, and longest sync time over this timeframe.
Total Projects (Item 1003)
   This module displays the total number of Projects that have been setup within the company, as well as a breakdown of the number of Projects by status. The status options are: Active, On Hold, and Archived. These statuses are manually set by Company Admins per Project.
Projects with Analytics ON (Item 1004)
   This module displays the total number of Projects that have analytics turned on.
Unique Team Members in Active Projects (Item 1005)
   This module displays the total number of unique team members who have synced Models within Projects that are set to a status of “Active”.
Health Indicators (Item 1006)
   This module displays the count of how many Projects have triggered each health indicator type for the listed elements. The mechanism for generating health indicators is discussed in greater detail below.
Revit Version Check (Item 1007)
   For each Revit Model, the system checks to see if all users who have synced that Model are using the same Revit Version within a selected date range. Item 1007 displays a red alert if users have synced using different Revit Major versions (for example, Revit 2018 and Revit 2019) and a yellow alert if users have synced using different Revit Minor versions (for example (Revit 2018.1 and Revit 2018.2). If all users have synced using the same Revit Major and Minor version, item 1007 displays a green checkmark.
   This is an important element, because syncing using different Revit Major or Minor versions could cause corruption issues and it is difficult to know what minor version all users have installed if it is not completely controlled by IT.
   If users have synced using a different Revit Major version, that indicates a Revit Model has been upgraded and it is important to catch it early if that wasn't intended since Revit is not backwards-compatible.
Top 10 Families (Item 1008)
   This is list of the top 10 families used across all Models in all Projects. Item 1008 also indicates whether that family was inserted from UNIFI (which is trademark for a software application offered by Applicant to perform some of the functions of integration server 103). This can help admins at a glance see what the most “popular” families are.
Project Admin Activity (Item 1009)
   Item 1009 is a history of admin activity for the following actions:
      Project Added
      Project Removed
      Project Status Changed
   Item 1009 displays the date and time the action occurred and the Admin User who performed the action.

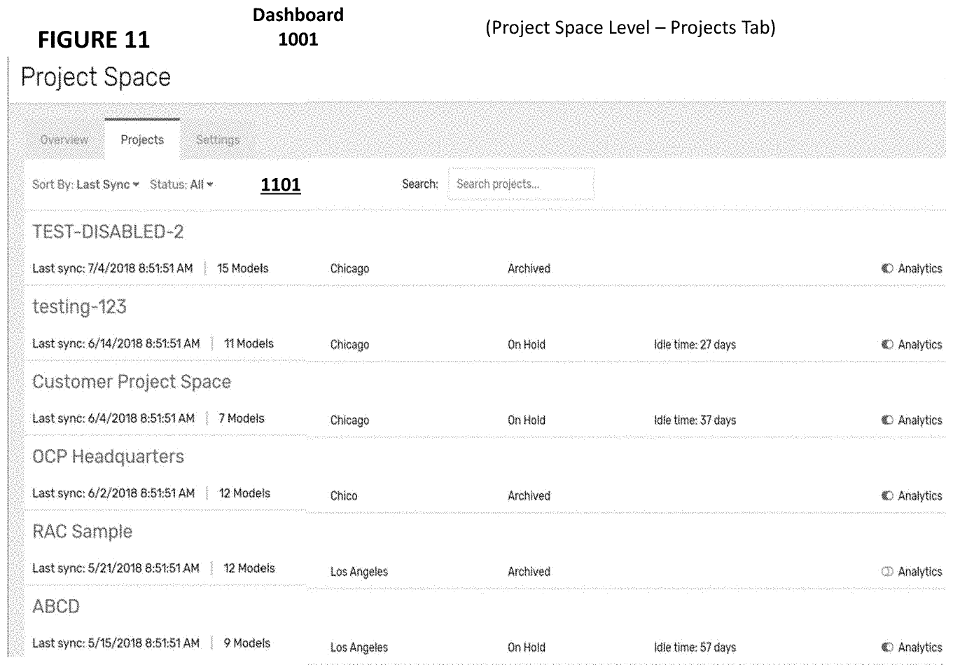

FIG. 11 depicts the “Projects” tab of the Project Space view, which contains the following information:
Project List (Item 1101)
   Users can search and sort this list as well as filter the list by status.
   New Projects can be created, and existing Projects can be modified or deleted.

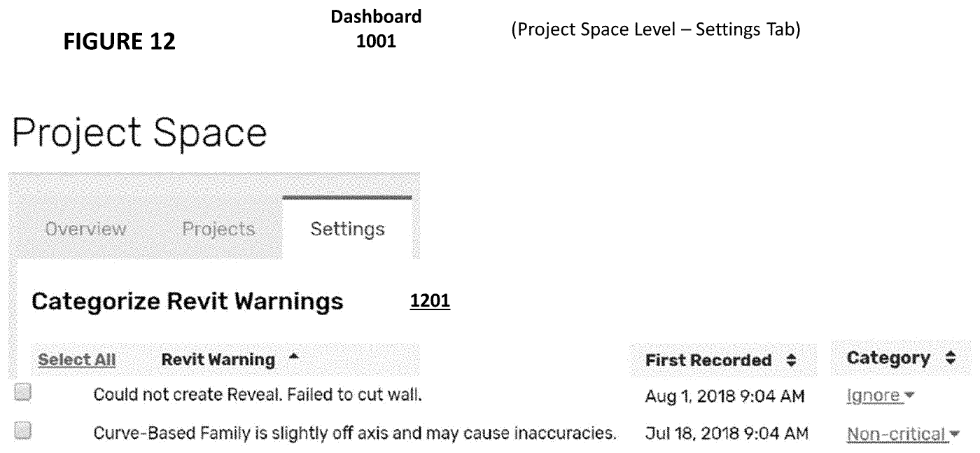

FIG. 12 depicts the “Settings” tab of the Project Space view, which contains the following information:
Categorize Revit Warnings (Item 1201)
   All Revit Warnings that have been seen across all Models in all Projects will be listed here.
   Company admins can assign each Revit Warning to a category of “Critical” or “Non-critical”. They can also “Ignore” Revit Warnings which means that warning will not trigger a health indicator.

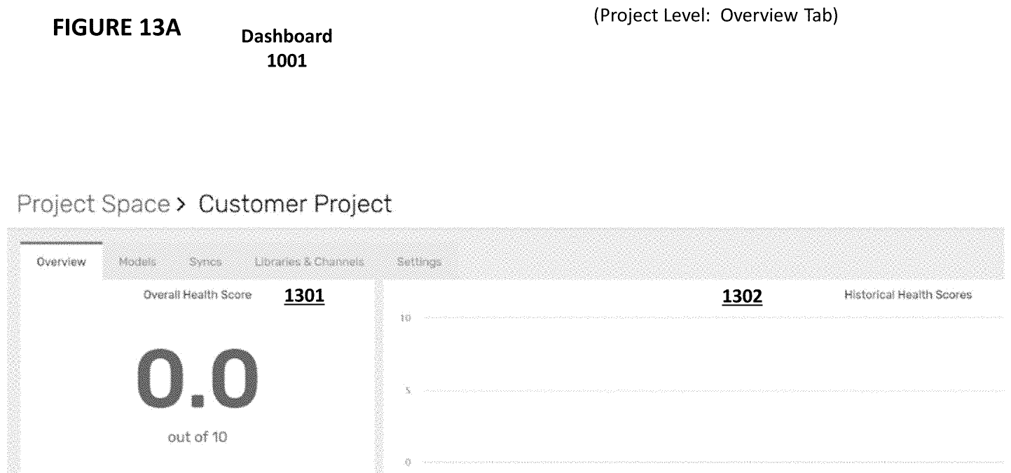

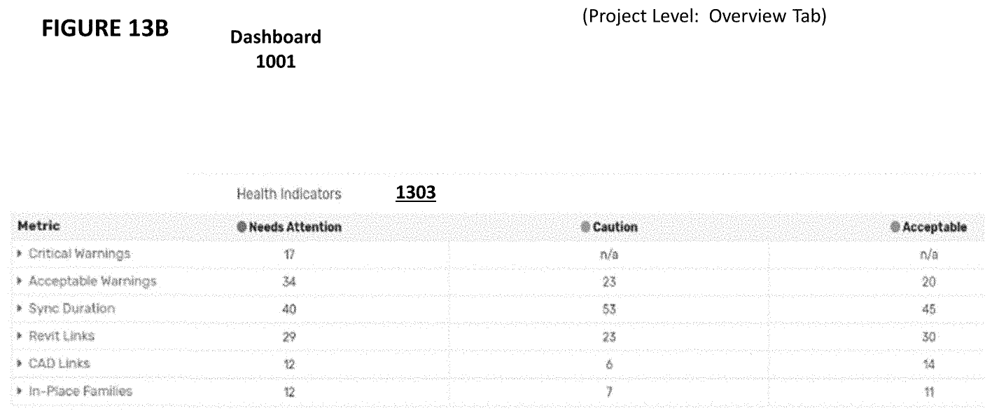

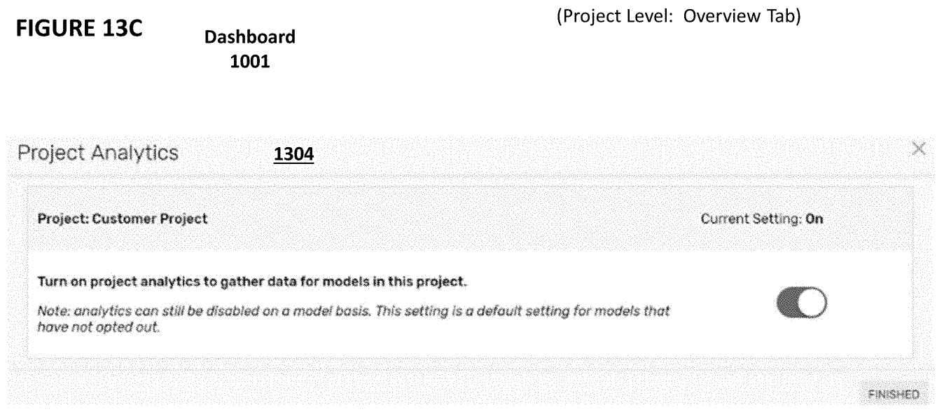

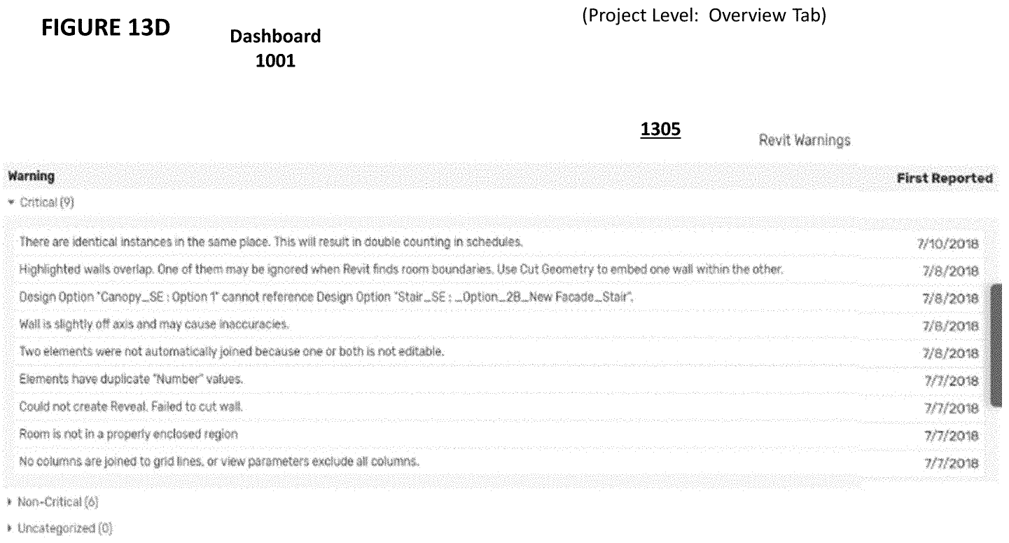

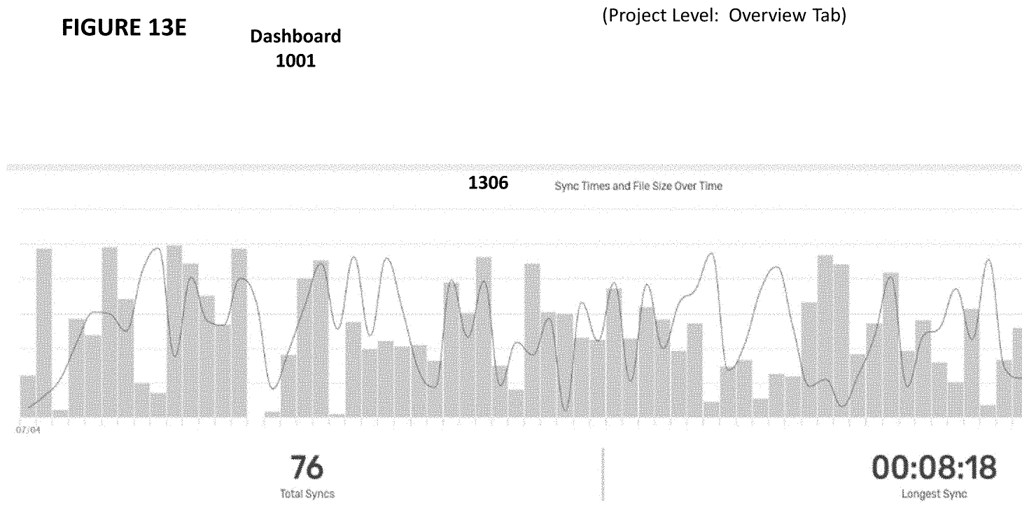

FIGS. 13-17 depict the “Project Level” view within dashboard 1001. At this level, users can see an overview of information relating to this specific Project, as well as all associated Revit Models as of the most recent sync. Admins can control whether analytics are gathered for each Project with the flip of a switch. If the switch is off, Project Analytics won't collect any data from any Model associated with that Project.

FIGS. 13A-13F depict the “Overview” tab of the Project Level view, which contains the following information:
Overall Health Score (Item 1301)
   A Project health score of zero (0) to ten (10) is displayed. This score is calculated by averaging the individual health scores of all Models associated with the Project. This score is recalculated each time a Model is synced. A poor health score indicates a greater likelihood that the Project will become corrupted or crash.
Historical Health Scores (Item 1302)
   This graph displays a history of the health scores for the Project over the past week, which allows users to see how the scores are trending (the same, improving, or getting worse).
Health Indicators (Item 1303)
   This module displays the total number of elements seen across all Models associated with the Project, by health indicator type. The mechanism for generating health indicators is discussed in greater detail below.
Project Analytics Selection (Item 1304)
   The user can configure the system to collect analytics for a project or to not collect analytics.
Revit Warnings (Item 1305)
   This module displays the Revit Warnings seen across all Models associated with the Project, by category, as of the last sync. If uncategorized Revit Warnings appear, an icon is displayed alerting the user to assign those Revit Warnings to a category.
Sync Times and File Size Over Time (Item 1306)
   This graph displays the time it took for each Revit sync operation correlated with the file size of the Revit Model at time it was synced over a selected date range for all Models associated with the Project. The user can click on any bar in this graph and it will take them to the corresponding Model's overview page.
   Statistics are shown for the total number of syncs, average sync time, and longest sync time relative to the selected date range.

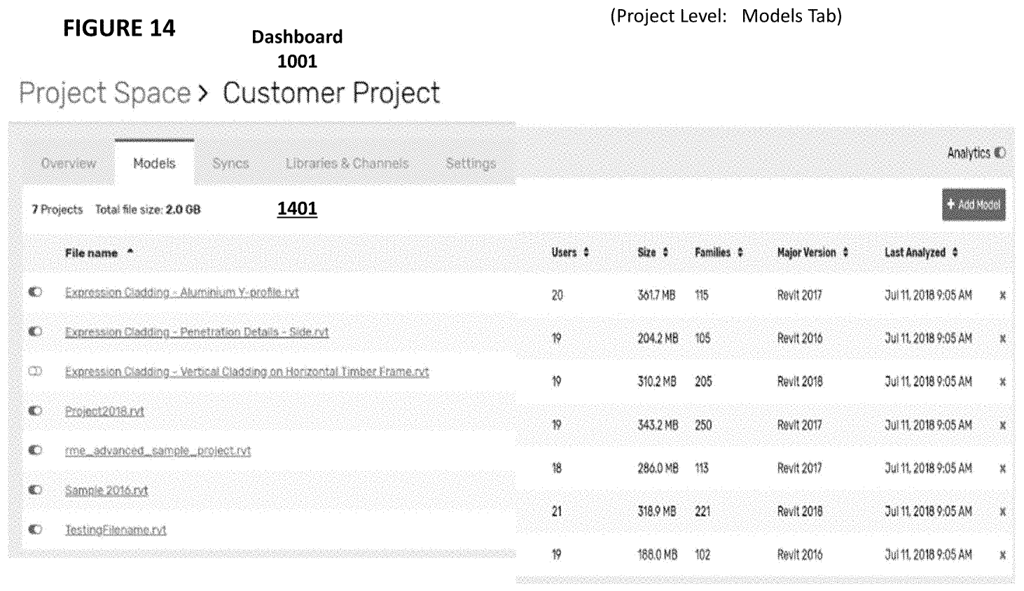

FIG. 14 depicts the “Model” tab of the Project Level view, which contains the following information:
Model List (Item 1401)
   A list of Models associated with the Project is listed, along with the following related information for each Model:
      Number of users who have synced that Model
      File size
      Total number of families
      Major Revit Version
      Last Updated (date and time)
   Models can be added to and removed from the Project from this tab.
      If a Model that's removed from a Project has data associated with it, the data will be maintained. New data will not be gathered for that Model until it is re-associated with a Project.

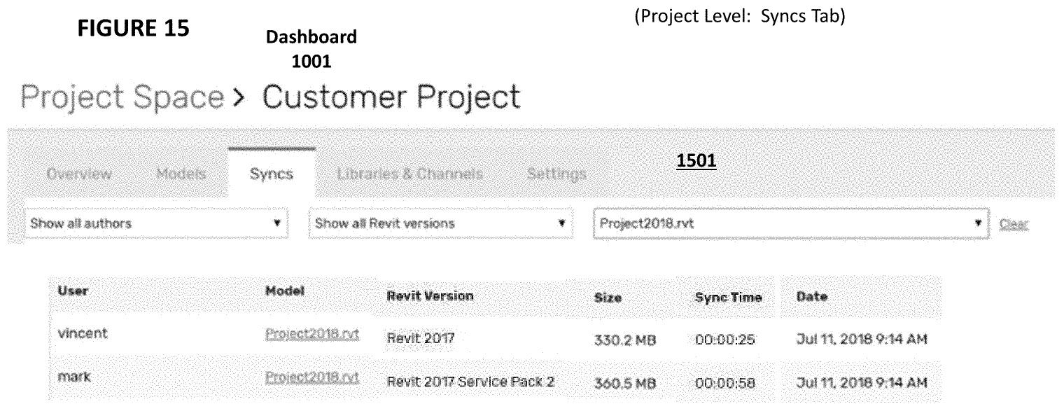

FIG. 15 depict the “Syncs” tab of the Project Level view, which contains the following information:
Sync List (Item 1501)
   A list of all sync operations that have occurred for all Models associated with the Project. Dropdowns are provided that allow a user to search and filter the list by User, Model, and Revit Version.

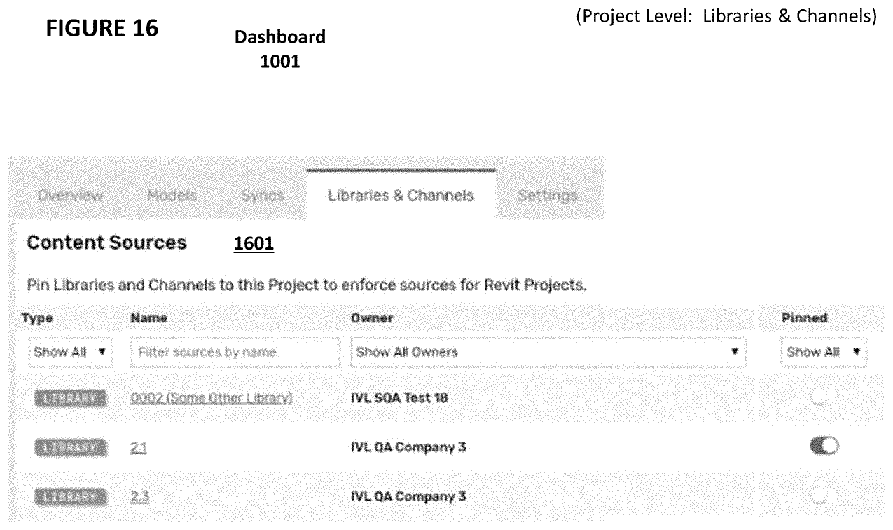

FIG. 16 depicts the “Libraries and Channels” tab of the Project Level view, which contains the following information:
Pinning Libraries and Channels (Item 1601)
   A list displaying all UNIFI Core Libraries and Channels for the user's company are displayed. Admins can pin any number of Libraries and Channels to the Project, which will then default users to those sources when searching for content in UNIFI Core while connected to any Model associated with the Project.

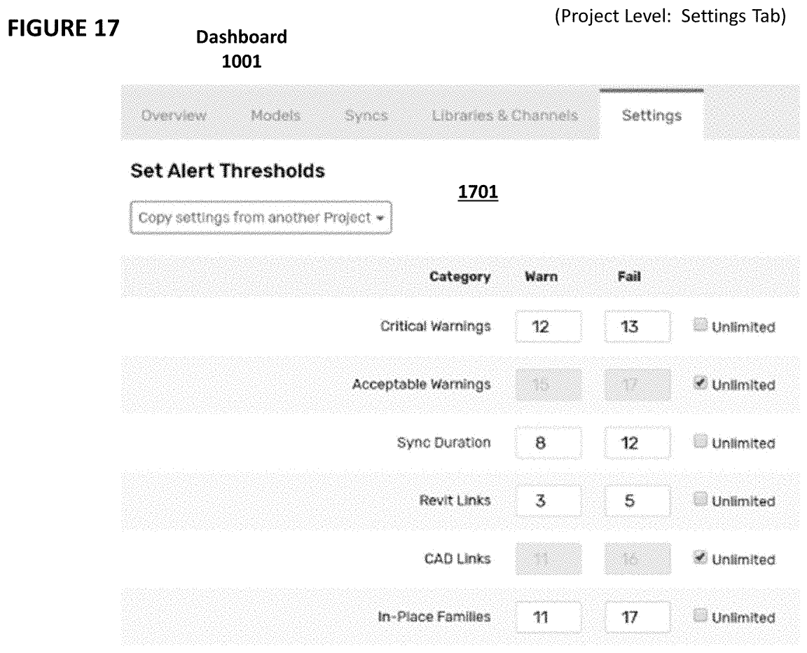

FIG. 17 depicts the “Settings” tab of the Project Level view, which contains the following information:
Set Health Indicator Threshold Values (Item 1701)
   Admins can set health indicator threshold values for the project for: Critical Revit Warnings, Non-critical Revit Warnings, Revit Links, CAD Links, CAD Imports, Imported Images, Sync Time (in seconds), In-Place Families, and Plan Regions.
   There are two threshold values that can be set for each element: “Caution” and “Needs Attention.”
      A health indicator of Acceptable will be displayed until the number of elements or sync time is equal to or greater than the Caution threshold value, at which point a health indicator of Caution will be triggered. When the number of elements or sync time is equal to or greater than the Needs Attention threshold value, a health indicator of Needs Attention will be triggered.
      If the Caution threshold value is set to zero (0) and the Needs Attention threshold value is set to one (1), a health indicator of Needs Attention will be triggered whenever the system sees at least one element present in any Model associated with the Project.
      Admins can ignore any element (other than Critical Warnings), in which case a health indicator of Acceptable will always be shown for that element.
   Health Indicator threshold values can be set on an individual Project by Project basis and can be copied from one Project to another.

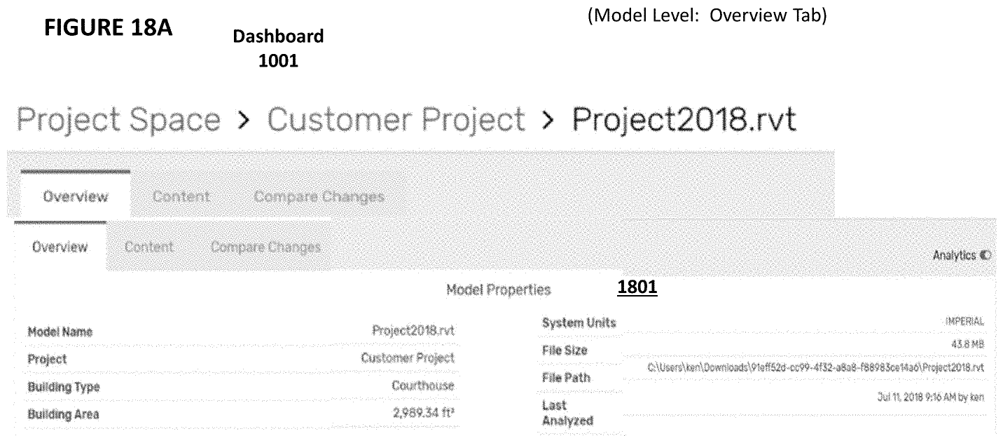

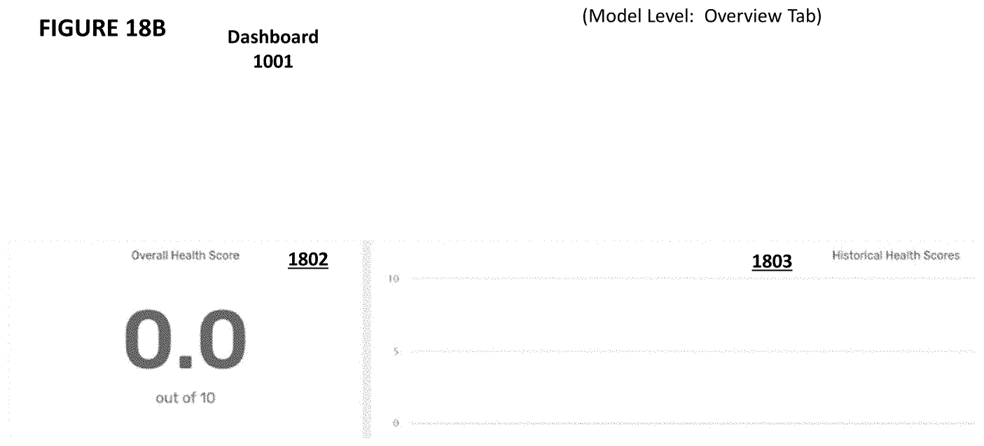

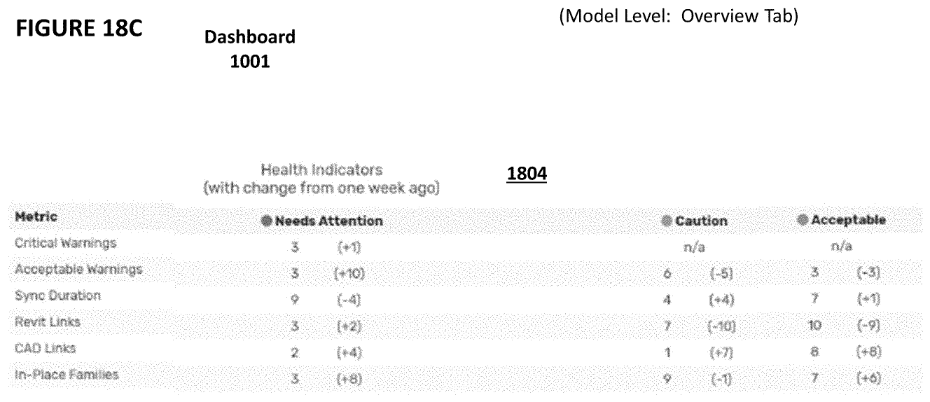

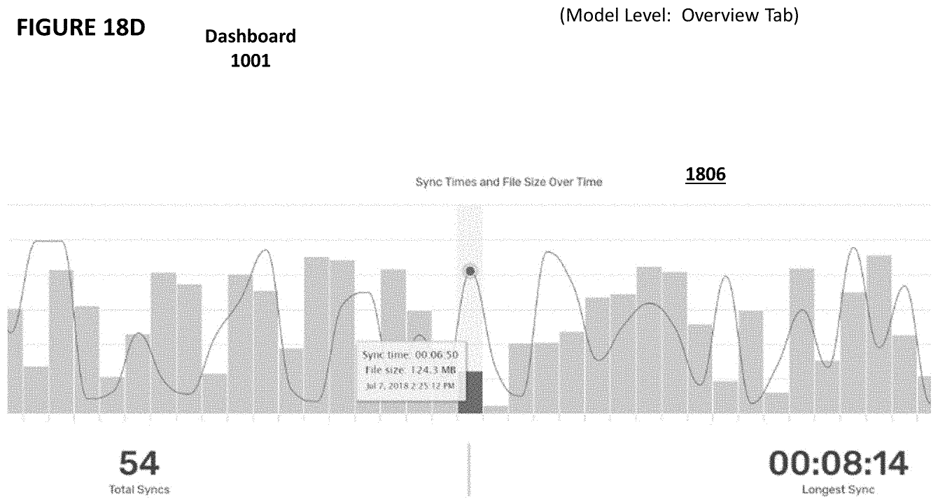

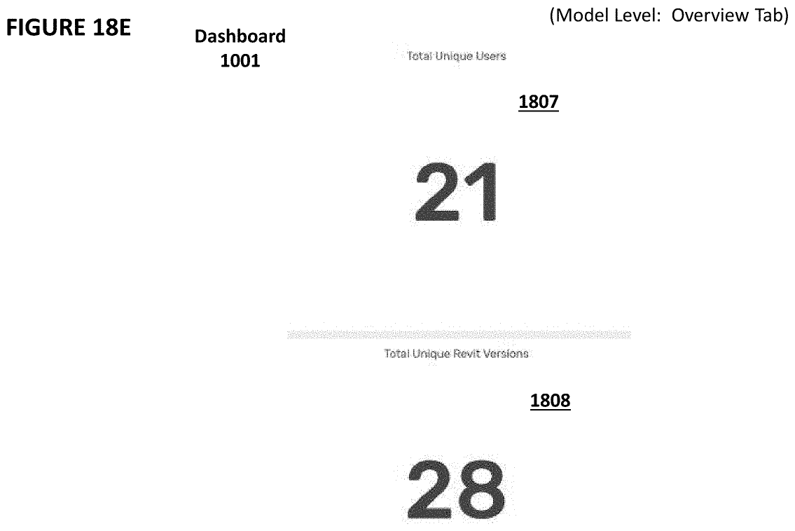

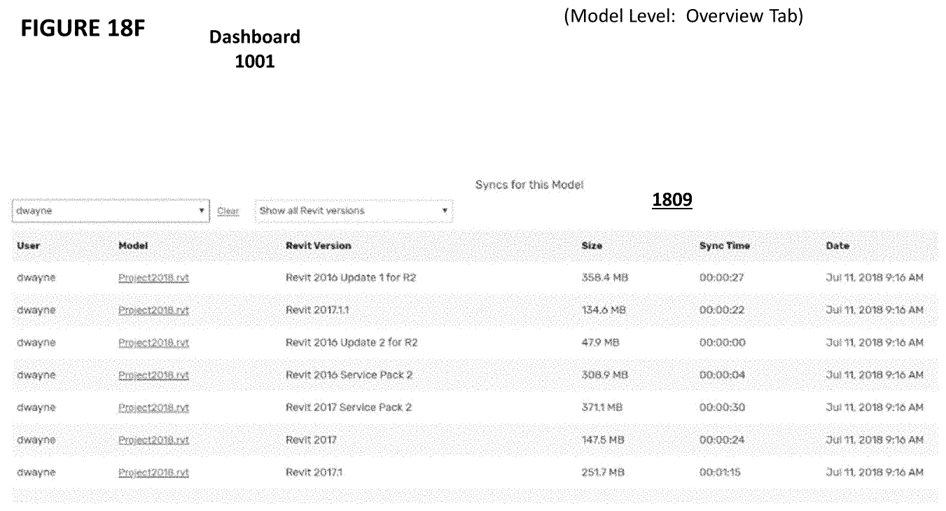

FIGS. 18-20 depict the “Model Space” view within dashboard 1001. At this level, users can see an overview of information relating to the specific Revit Model as of the most recent sync. Admins can control whether analytics are gathered for each Model with the flip of a switch. If the switch is off, Project Analytics will not collect any data from that Model, even if the Project that Model is associated with has analytics gathering turned on. By default, the gather analytics setting for a Model will be controlled by the associated Project.

FIGS. 18A-18F depict the “Overview” tab of the Model Space view, which contains the following information:
Model Properties (Item 1801)
Overall Health Score (Item 1802)
   A Model health score of zero (0) to ten (10) is displayed. This overall Model score is calculated by applying a score to each health indicator and then averaging those health indicator scores. This score is recalculated each time the Model is synced.
Historical Health Scores (Item 1803)
   This graph displays a history of the health scores for the Model over the past week, which allows users to see how the scores are trending (the same, improving, or getting worse).
Health Indicators (Item 1804)
   This module displays the total number of elements seen in the Model by health indicator type along with the change in that value from the previous sync. The mechanism for generating health indicators is discussed in greater detail below.
Revit Warnings
   This module displays the Revit Warnings seen in the Model, by category, as of the last sync. If uncategorized Revit Warnings appear, an icon is displayed alerting the user to assign those Revit Warnings to a category.
Sync Times and File Size Over Time (Item 1806)
   This graph displays the time it took for each Revit sync operation correlated with the file size of the Revit Model at time it was synced over a selected date range.
   Statistics are shown for the total number of syncs, average sync time, and longest sync time relative to the selected date range.
Total Unique Users (Item 1807)
   This module displays the total number of unique team members who have synced the Model.
Total Unique Revit Versions (Item 1808)
   This module displays the total number of Revit Versions (Major and Minor) seen across users who have synced the Model.
Syncs for this Model (Item 1809)
   A list of all sync operations that have occurred for the Model. Dropdowns are provided that allow a user to search and filter the list by User, Model, and Revit Version.

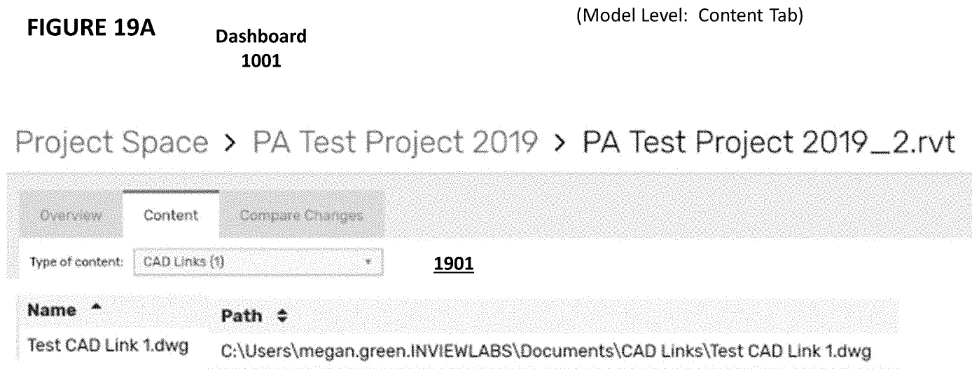

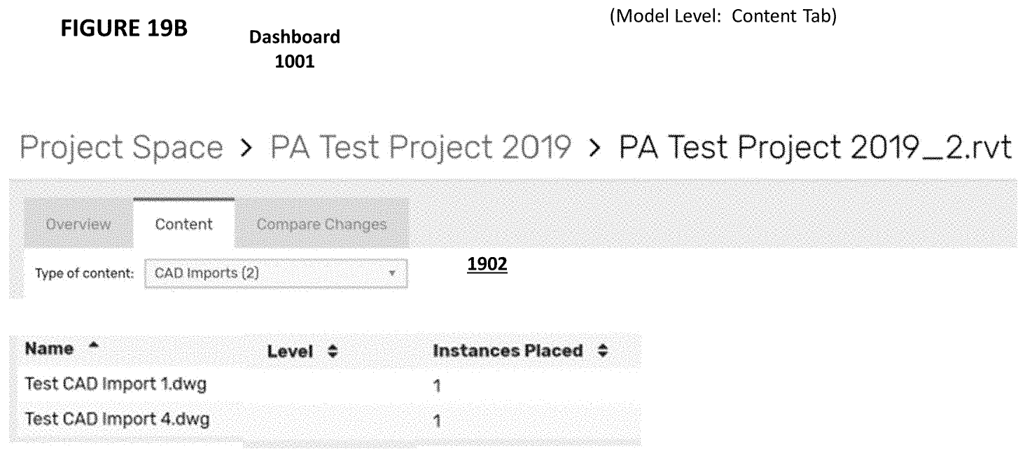

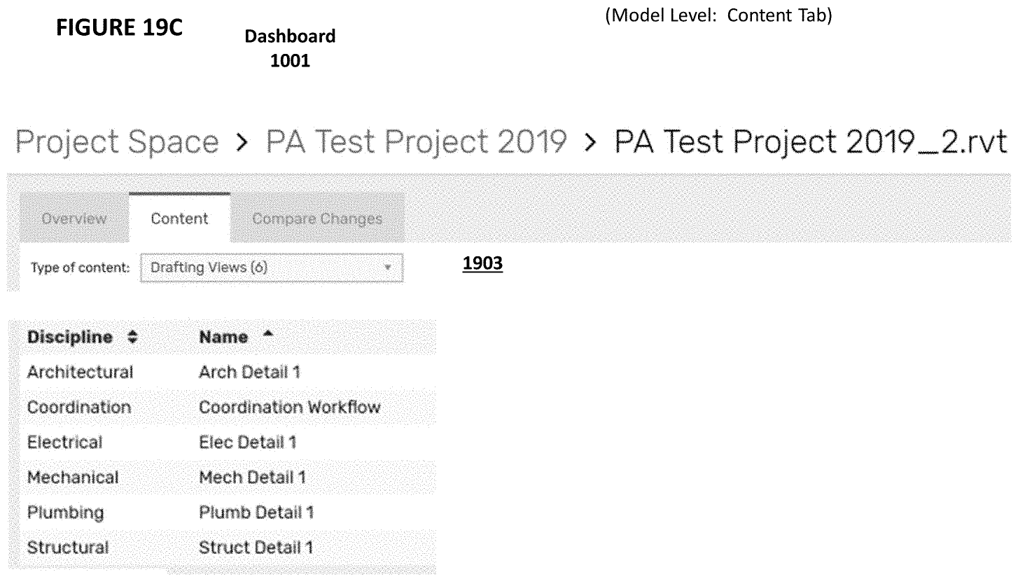

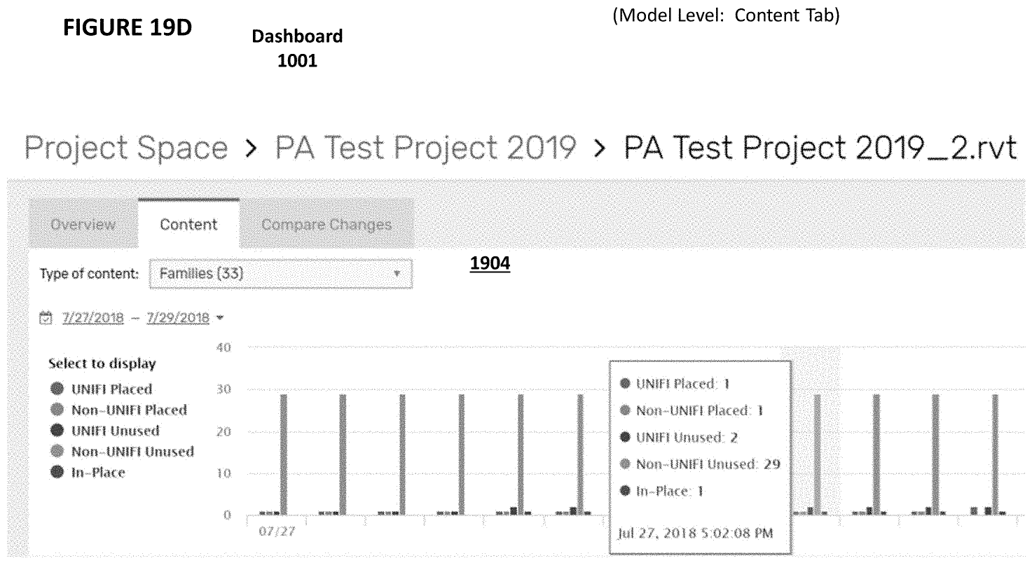

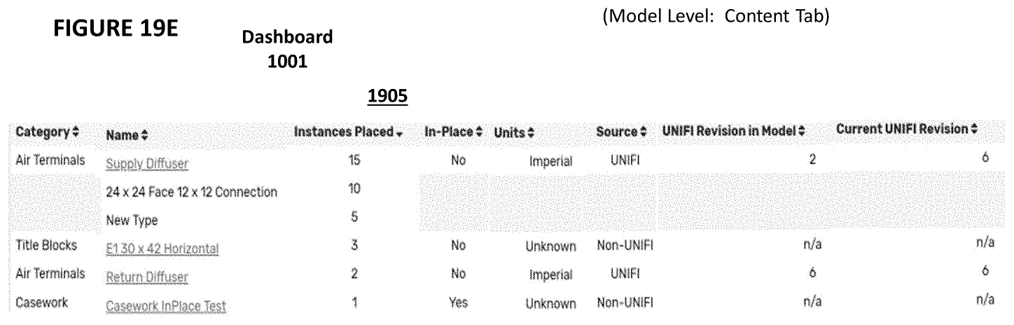

FIGS. 19A-19E depicts the “Content” tab of the Project Space view. Detail relating to the following content types are provided to help diagnose and prevent Revit Model health issues as well as give design team members visibility into the information. Revit Models can take a long time to open and it can take a while to look through the Revit Model to find the information you need, having this information available in a web interface can save the design team members time. The “Content” tab of the Project Space view contains the following information:
CAD Links (Item 1901)
   The Name and Path of all CAD Links seen in the Model are displayed.
   CAD Links are known to greatly affect Revit Model performance, so it is important to limit their use.
CAD Imports (Item 1902)
   The Name of all imported CAD files used in the Model are displayed, along with the number of instances of each file.
Drafting Views (Item 1903)
   The Discipline and Name of all Drafting Views seen in the Model are displayed.
   There are no health risks associated with drafting views. However, an excessive number of views in a project is something to watch out for as it can bloat the file size and affect Revit Model performance.
   It is important for design team members to have visibility into this information to ensure the proper drafting views are present in the Model.
Families (Item 1904)
   A graph is displayed showing the total number of families seen in the Model at each sync operation within a selected date range and broken down by: UNIFI Placed, Non-UNIFI Placed, UNIFI Unused, Non-UNIFI Unused, and In-Place Families.
      UNIFI Placed—Families that were inserted into the Model using UNIFI Core and one or more instances of the families have been placed within the Model. If a firm has standardized on using content from UNIFI Core these families should be the most prevalent.
      Non-UNIFI Placed—Families that were inserted into the Model from somewhere other than UNIFI Core and one or more instances of the families have been placed within the Model. Some of these are unavoidable as they're part of the Revit template, however if a firm has standardized on using content from UNIFI Core these families should be minimal.
      UNIFI Unused—Families that were inserted into the Model using UNIFI Core and no instances of the families have been placed within the Model. It is important to keep unused families to a minimum as it bloats the file size and can affect Revit Model performance.
      Non-UNIFI Unused—Families that were inserted into the Model from somewhere other than UNIFI Core and no instances of the families have been placed within the Model. It is important to keep unused families to a minimum as it bloats the file size and can affect Revit Model performance.
      In-Place Families—These are families that are created within a Revit Model and cannot be reused outside that Revit Model. They are generally considered bad practice and should only be used in specific circumstances (for example, a highly custom piece of furniture that will not be reused).
   A list of details (Item 1905) for each family seen in the Model is displayed, including:
      Revit Category
      Family Name
      Number of Instances Placed
      Whether it is an In-Place Family
      Units (Imperial or Metric)
      Source (UNIFI or Non-UNIFI)
      The UNIFI Revision Number seen in the Model
      The UNIFI Revision Number currently active in UNIFI Core
   Both the graph and list can be filtered by: UNIFI Placed, Non-UNIFI Placed, UNIFI Unused, Non-UNIFI Unused, and In-Place Families.
Levels
   The Name and Elevation of all levels seen in the Model are displayed.
   There are no health risks associated with levels, however it is important for design team members to have visibility into this information to ensure the proper levels are present in the Model.
Phases
   The Name of all phases in the Model are displayed.
   There are no health risks associated with phases, however it is important for design team members to have visibility into this information to ensure the proper phases are present in the Model.
Revisions
   The Number, Name, Date, Issue Status, Issued By, and Issued To fields of all revisions in the Model are displayed.
   There are no health risks associated with revisions. However it is important for design team members to have visibility into this information to ensure the proper revisions are present in the Model.
Revit Links
   The Name and Path of all Revit Links seen in the Model are displayed.
   A large quantity of Revit Links attached to a Model can bloat the file size and affect Revit Model performance.
   It is important for design team members to have visibility into this information to ensure the proper Revit Links are attached to the Model for coordination.
Rooms
   The Number, Name, Area, and Level of all rooms in the Model are displayed.
   Duplicate rooms and unplaced rooms can generate Revit Warnings, which can then affect Revit Model performance, so it is important for design team members to have visibility into this information to ensure the proper rooms are present in the Model.
Schedules
   The Name of all Schedules seen in the Model are displayed.
   There are no health risks associated with schedules, however an excessive number of schedules in a project is something to watch out for as it can bloat the file size and affect Revit Model performance.
   It is important for design team members to have visibility into this information to ensure the proper schedules are present in the Model.
Sheets
   The Number and Name of all Sheets seen in the Model are displayed.
   There are no health risks associated with sheets, however an excessive number of views in a project is something to watch out for as it can bloat the file size and affect Revit Model performance.
   It is important for design team members to have visibility into this information to ensure the proper sheets are present in the Model as this is their deliverable.
Spaces
   The Number, Name, Area, and Level of all spaces in the Model are displayed.
   Duplicate spaces and unplaced spaces can generate Revit Warnings, which can then affect Revit Model performance, so it is important for design team members to have visibility into this information to ensure the proper rooms are present in the Model.
Worksets
   The Name and Type of user worksets seen in the Model are displayed.
   A large quantity of user worksets can affect Revit Model performance.
   It is important for design team members to have visibility into this information to ensure the proper worksets are present in the Model.

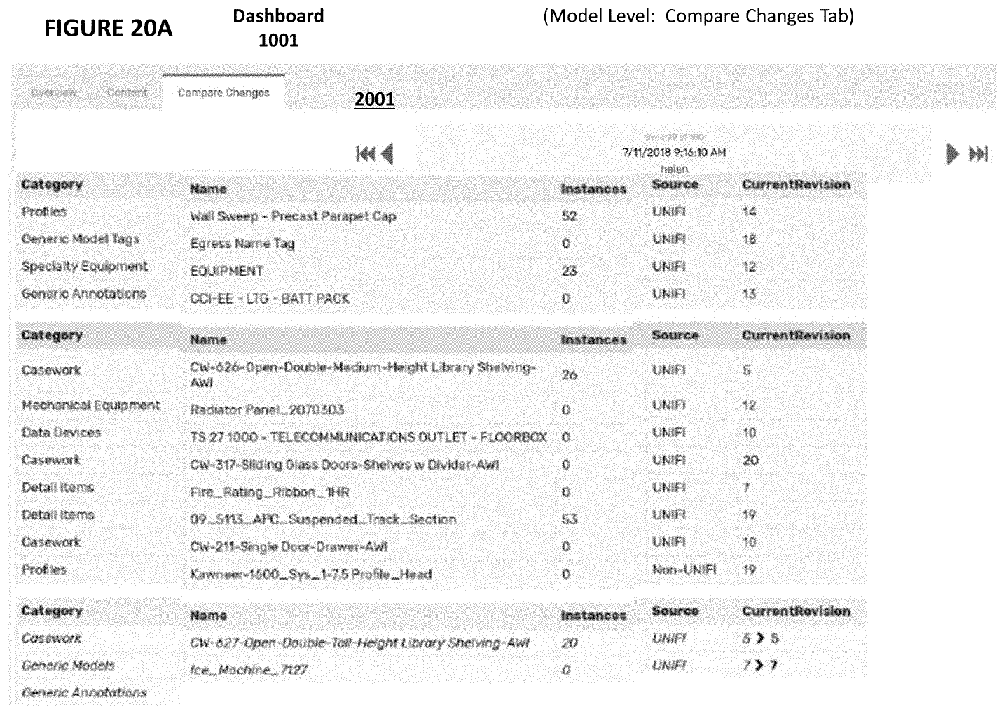

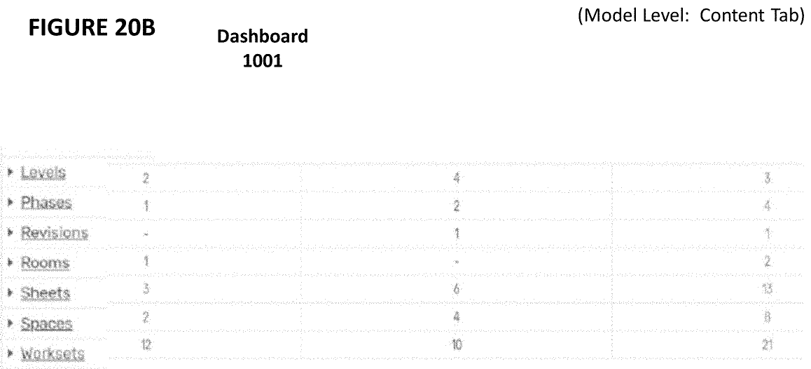

FIGS. 20A-20B depicts the “Compare Changes” tab of the Project Space view, which contains the following information:
Compare Changes (Item 2001)
   Users can view what changed between two syncs for the Model relative to the same content details listed in the Content Tab. This is critical to the admins ability to quickly and efficiently troubleshoot issues. They can see the date and time each sync occurred, as well as who performed each sync. Not only is this information helpful in troubleshooting issues, it can also be used to reinforce design team Revit training.

### Generation of Health Indicators

A key aspect of the embodiments of FIGS. 9-20 is the ability of compliance module 413 to generate health indicators (such as health indicators 1006, 1303, and 1804)

The model elements outlined below all have the potential to negatively impact the health of project 901 (which in the example of FIGS. 10-20 would be a Revit Model). When any of these issues becomes too prevalent, project 901 is at an increased risk of performance degradation, or even becoming corrupted. When project 901 crashes or becomes corrupted, the cost of the resulting loss of data and work is often in the tens of thousands of dollars. Designers on the project must then redo their work and the downtime often results in project delays.

With health indicators such as health indicators 1006, 1303, and 1804, users (e.g., BIM managers) are given real-time visibility into any elements that may put project 901 at risk, enabling them to proactively address those issues and prevent project 901 from crashing or becoming corrupted. This visibility also arms users with the information necessary to quickly and efficiently troubleshoot any other issues that may occur.

Each time a user syncs project 901 (e.g., a Revit Model) with AEC server 102, integration module 313 and/or integration server 103 checks to see how many of the following elements exist in project 901: Critical Revit Warnings, Non-critical Revit Warnings, Revit Links, CAD Links, CAD Imports, Imported Images, In-Place Families, and Plan Regions. Integration module 313 and/or integration server 103 also collects the amount of time (in seconds) it takes for the sync operation to complete. Additional detail regarding these events is the following:
Revit Warnings—When integration server 103 collects data from a Revit projects, Revit Warnings are all grouped together. However, not all Revit Warnings should be treated the same. Some Revit Warnings can potentially cause Model corruption or have other critical consequences, whereas other Revit Warnings don't affect model performance or are unavoidable. For this reason, the system gives Company Admins the ability to assign a category of either “Critical” or “Non-critical” to each Revit Warning, so that the system knows which health indicator to trigger.
Revit Links, CAD Links, CAD Imports, and Imported Images—Firms have different standards around how many of these types of elements should be allowed in the Model.
In-Place Families—These are families that are created within a Revit Model and cannot be reused outside that Revit Model. They are generally considered bad practice and should only be used in specific circumstances (for example, a highly custom piece of furniture that will not be reused).
Plan Regions—These are used to define an area of a plan that needs to be viewed at a different height than the rest of the plan. This can cause issues if a user doesn't know the region exists and they are unable to see an element they've placed within that boundary.
Sync Time—The amount of time it takes for a user to sync a Revit Model can be a key indication of the Model health. Syncs should take no longer than 5-10 minutes, depending on the size of the Model and the user's network connection. Users don't usually let admins know if syncs are taking longer than that and typically only say something once an error occurs, so providing visibility into this data is important as it gives admins the ability to see potential issues developing and proactively mitigate them.

A user can set thresholds at the Project Level for the above listed elements to inform integration module 312 and/or integration server 102 when to trigger a health indicator of Acceptable, Caution, or Needs Attention for each element. By default, the Caution threshold will be set to zero (0) and the Needs Attention threshold will be set to one (1). This means that integration module 312 and/or integration server 102 will trigger a health indicator of Needs Attention whenever there is at least one of each element type present in the model and the sync time takes at least one second. The threshold for Critical Revit Warnings cannot be modified and will always be set to zero (0) and one (1). Threshold settings for a Project apply to all Revit Models associated with that Project. Company Admins can copy threshold settings from one Project to another.

Users are provided with tools to resolve the compliance errors identified in the processes described above.

Beginning on the Project Space Overview tab, a user can see what type of health indicator(s) have been triggered for each data type listed above. They can expand the list to see which Projects have triggered those health indicators. Each Project Name is a hyperlink, so the user can click that link to go to that Project's Overview page.

On the Project Overview tab, they will see the same health indicator module. At this level, the numbers shown indicate the total number of elements (or total sync time) by health indicator type for all Models associated with that Project. They can expand the list to see which Models have triggered those health indicators. Each Model Name is a hyperlink, so the user can click that link to go to that Model's Overview page.

On the Model Overview tab, they will again see the same health indicator module. At this level, the numbers shown indicate the total number of elements (or total sync time) by health indicator type for this Model.

To view supporting data for Sync Time, there is a graph displaying the correlation between sync time and file size over a selected timeframe. There is also a list of all sync operations for that Model that can be filtered by user.

To view supporting data for Revit Warnings, there is a module that displays each Revit Warning seen in that Model by category as of the most recent sync operation.

To view supporting data for the other element types (Revit Links, CAD Links, etc.), they would navigate to the Model Content tab to view tables of data related to each element type. These tables display the information collected from the Model as of the most recent sync operation.

The supporting data should provide the user with enough information to resolve any issues within the Revit Model.

### Report to Manufacturer Regarding Usage of Objects

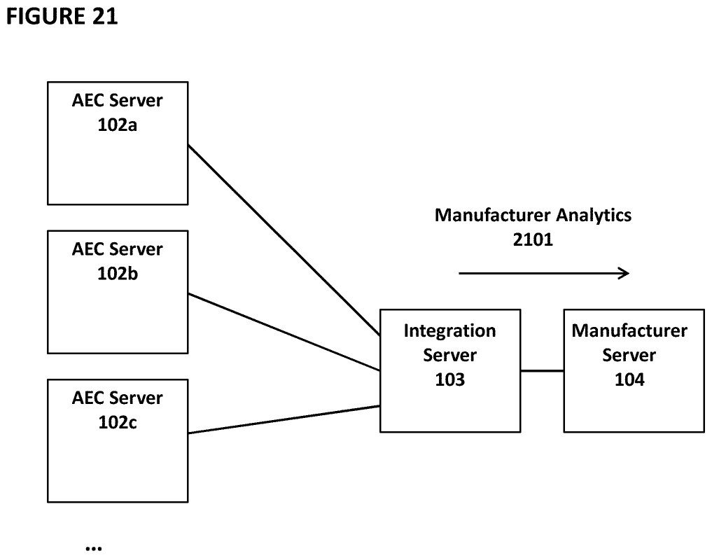

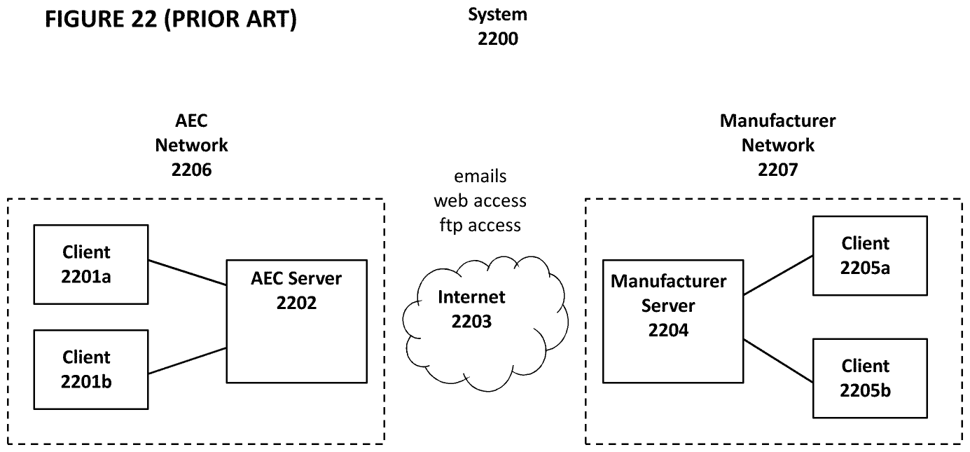

FIG. 21 depicts another aspect of the invention. Here, a plurality of AEC servers (AEC servers 102a, 102b, 102c, . . . ) are working on projects hosted by integration server 103. Integration server 103 collects data to generate manufacturer analytics 2101 regarding the use of all objects that had been generated by manufacturer server 104 and provides manufacturer analytics 2102 to manufacturer server 104. This allows the operator of manufacturer server 104 to have insight into how its objects are being used that was not possible in the prior art. Examples of manufacturer analytics 2102 for a particular object, Object X, can include:
Number of projects in which Object X has been used;
Average number, minimum number, and maximum number of instances of use of Object X within each project;
Types of projects in which Object X has been used;
Geographic locations of projects in which Object has been used; and
Other objects with which Object X has most frequently been used.

References to the present invention herein are not intended to limit the scope of any claim or claim term, but instead merely make reference to one or more features that may be covered by one or more of the claims. Materials, processes and numerical examples described above are exemplary only, and should not be deemed to limit the claims. It should be noted that, as used herein, the terms “over” and “on” both inclusively include “directly on” (no intermediate materials, elements or space disposed there between) and “indirectly on” (intermediate materials, elements or space disposed there between). Likewise, the term “adjacent” includes “directly adjacent” (no intermediate materials, elements or space disposed there between) and “indirectly adjacent” (intermediate materials, elements or space disposed there between). For example, forming an element “over a substrate” can include forming the element directly on the substrate with no intermediate materials/elements there between, as well as forming the element indirectly on the substrate with one or more intermediate materials/elements there between.

What is claimed is:

1. A server for analyzing a building information model and determining compliance of the model with a set of predetermined standards, comprising:
non-volatile storage containing the set of predetermined standards for the building information model; and
a processor executing a compliance module, wherein the compliance module comprises software code for comparing the building information model to the set of predetermined standards upon the occurrence of a triggering event and issuing a report comprising results of the comparing of the building information model to the set of predetermined standards.

2. The server of claim 1, wherein the triggering event is a change made to the building information model.

3. The server of claim 1, wherein the triggering event is a sync of the building information model to the server.

4. The server of claim 1, wherein the report identifies a portion of the set of predetermined standards with which the building information model does not comply.

5. The server of claim 1, wherein the set of predetermined standards comprises rules specific to the building information model.

6. The server of claim 1, wherein the set of predetermined standards comprises rules applicable to a plurality of building information models.

7. The server of claim 1, wherein the report comprises a health score for the building information model.

8. The server of claim 1, wherein the report comprises the number of syncs of the building information model over a period of time.

9. The server of claim 1, wherein the report comprises an average duration for syncs of the building information model.

10. The server of claim 1, wherein the report comprises file size of the building information model over time.

11. A method for analyzing a building information model and determining compliance of the model with a set of predetermined standards, comprising:
storing the set of predetermined standards in non-volatile storage accessible to a server;
comparing, by the server, a building information model to the set of predetermined standards upon the occurrence of a triggering event;
issuing, by the server, a report comprising results of the comparing of the building information model to the set of predetermined standards.

12. The method of claim 11, wherein the triggering event is a change made to the building information model.

13. The method of claim 11, wherein the triggering event is a sync of the building information model to the method.

14. The method of claim 11, wherein the report identifies a portion of the set of predetermined standards with which the building information model does not comply.

15. The method of claim 11, wherein the set of predetermined standards comprises rules specific to the building information model.

16. The method of claim 11, wherein the set of predetermined standards comprises rules applicable to a plurality of building information models.

17. The method of claim 11, wherein the report comprises a health score for the building information model.

18. The method of claim 11, wherein the report comprises the number of syncs of the building information model over a period of time.

19. The method of claim 11, wherein the report comprises an average duration for syncs of the building information model.

20. The method of claim 11, wherein the report comprises file size of the building information model over time.
